(19) United States
(12) Patent Application Publication
(10) Pub. No.: US 2013/0120226 A1
(43) Pub. Date: May 16, 2013

(54) SHIFTED QUAD PIXEL AND OTHER PIXEL MOSAICS FOR DISPLAYS

(71) Applicants: Kostadin D. Djordjev, San Jose, CA (US); Richard Yeh, Sunnyvale, CA (US); Alan G. Lewis, Sunnyvale, CA (US)

(72) Inventors: Kostadin D. Djordjev, San Jose, CA (US); Richard Yeh, Sunnyvale, CA (US); Alan G. Lewis, Sunnyvale, CA (US)

(73) Assignee: QUALCOMM MEMS Technologies, Inc., San Diego, CA (US)

(21) Appl. No.: 13/493,944

(22) Filed: Jun. 11, 2012

Related U.S. Application Data
(60) Provisional application No. 61/558,992, filed on Nov. 11, 2011.

(51) Int. Cl. G09G 3/20; B23P 17/04

(52) U.S. Cl. 345/55; 29/428

(57) ABSTRACT

This disclosure provides systems and apparatuses having pixels with various display element arrangements. In one aspect, a passive matrix display apparatus includes a plurality of red display elements extending along a direction parallel to a first row, the plurality of red display elements addressed by a single first common line, a plurality of green display elements extending along a direction parallel to a second row, the plurality of green display elements addressed by a single second common line, and a plurality of blue display elements extending along a direction parallel to a third row, the plurality of blue display elements addressed by a single third common line, where the number of green display elements in the display is greater than one of a number of red display elements in the display and a number of blue display elements in the display.

### CROSS-REFERENCE TO RELATED APPLICATIONS

The disclosure claims priority to U.S. Provisional Patent Application No. 61/558,992 filed on Nov. 11, 2011, entitled “SHIFTED QUAD PIXEL AND OTHER PIXEL MOSAICS FOR DISPLAYS,” which is assigned to the assignee hereof, and is considered part of and is incorporated by reference herein.

### TECHNICAL FIELD

This disclosure relates to pixel configurations for electromechanical display systems.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a passive matrix display apparatus including a plurality of red display elements disposed in a first row such that each of the plurality of red display elements is disposed adjacent to at least one other of the plurality red display elements, a plurality of green display elements disposed in a second row such that each of the plurality of green display elements is disposed adjacent to at least one other of the plurality green display elements, a plurality of blue display elements disposed in a third row such that each of the plurality of blue display elements is disposed adjacent to at least one other of the plurality blue display elements, and a second plurality of green display elements disposed in a fourth row such that each of the second plurality of green display elements is disposed adjacent to at least one other of the second plurality green display elements. In such an apparatus, the second row can be adjacent to, and between, the first row and the third row, and the third row can be adjacent to, and between, the second row and the fourth row. In some implementations, the first row of red display elements, the second row green display elements, the third row of blue display elements, and the fourth row of green display elements define a four row display element pattern, and wherein the display further comprises at least four additional rows of display elements arranged in the four row display element pattern. The display apparatus can further include a repeating pattern of the first, second, third, and fourth rows of display elements. The display apparatus can also include a plurality of pixels, each pixel in the plurality of pixels including one red display element, a first green display disposed adjacent to the red display element, a second green display element disposed adjacent to the first green display element, and a blue display element disposed adjacent to the second green display element.

The display apparatus can further include a plurality of pixels, each pixel in the plurality of pixels including one red display element disposed in the first row, two green display elements disposed in the second row, and one blue display element disposed in the third row. In some implementations, the display apparatus can include a plurality of red display elements disposed in a fifth row such that each of the display elements in the fifth row are disposed adjacent to at least one other red display element in the fifth row, where the fifth row is adjacent to the fourth row and disposed such that the fourth row is between the third row and the fifth row, a first plurality of pixels, each pixel in the first plurality of pixels including one red display element of the first row, a first green display of the second row disposed adjacent to the red display element, a second green display element of the second row disposed adjacent to the first green display element, and a blue display element of the fourth row disposed adjacent to the second green display element, and a second plurality of pixels, each pixel in the second plurality of pixels including one blue display element of the third row, a first green display of the fourth row disposed adjacent to the blue display element, a second green display element of the fourth row disposed adjacent to the first green display element, and a red display element of the fifth row disposed adjacent to the second green display element.

In some implementations of the display apparatus, the first green display elements, the second green display elements, the red display elements, and the blue display elements have the same size active area. In some implementations, the active areas of the first and second green display elements in a pixel in the first plurality of pixels are the same size as the active areas of the first and second green display elements in a pixel in the second plurality of pixel, and the active areas of the green display elements are smaller than the active areas of the red display elements and smaller than the active areas of the blue display elements. In some implementations, the active areas of the green display elements of the second row are the same size as the active areas of the green elements of the fourth row, and wherein the active areas of the green display elements of the second and fourth row are smaller than the active areas of the red display elements and the blue display elements. In some implementations, the active areas of the green display elements in a pixel of the first plurality of pixels is larger than the active areas of the green display elements in a pixel of the second plurality of pixels. In other implementations, the active area of a green display element of the second row is the same size as the active area of a red display element in the first row and the active area of a blue display element in the third row, and the active area of a green display element of the fourth row is smaller the active area of a green display element of the second row. In some implementations, the display elements are interferometric modulators. The display apparatus can further include a display including the plurality of red display elements, the first plurality of green display elements, the plurality of blue display elements, and the second plurality of green display elements, a processor that is configured to communicate with the display, the processor being configured to process image data, and a memory device that is configured to communicate with the processor. The display apparatus can further include a driver circuit configured to send at least one signal to the display. In some implementations, the display apparatus further includes a controller configured to send at least a portion of the image data to the driver circuit. The display apparatus can also include, in some implementations, an image source module configured to send the image data to the processor. The image source module can include at least one of a receiver, transceiver, and transmitter.

Another innovative aspect of the subject matter described in this disclosure can be implemented in a passive matrix display apparatus including means for displaying red information in a first row, the red displaying means each disposed adjacent to at least one other red displaying means in the first row, means for displaying green information in a second row, the green displaying means each disposed adjacent to at least one other green displaying means in the second row, means for displaying blue information in a third row, the blue displaying means each disposed adjacent to at least one other blue displaying means in the third row, and means for displaying green information in a fourth row, the green displaying means each disposed adjacent to at least one other green displaying means in the fourth row, a first plurality of pixels, each pixel in the first plurality of pixels including a red displaying means of the first row, a first green displaying means of the second row disposed adjacent to the red displaying means, a second green displaying means of the second row disposed adjacent to the first green displaying means, and a blue displaying means disposed adjacent to the second green displaying means, and the second row is adjacent to, and between, the first row and the third row, and wherein the third row is adjacent to, and between, the second row and the fourth row. In some implementations, the red displaying means includes a plurality of interferometric modulators configured to reflect red-colored light, the green displaying means includes a plurality of interferometric modulators configured to reflect green-colored light, and the blue displaying means includes a plurality of interferometric modulators configured to reflect blue-colored light.

Another innovative aspect of the subject matter described in this disclosure can be implemented in a method of manufacturing a passive matrix display apparatus, the method including providing a plurality of red display elements disposed in a first row such that each of the plurality of red display elements is disposed adjacent to at least one other of the plurality red display elements, providing a plurality of green display elements disposed in a second row such that each of the plurality of green display elements is disposed adjacent to at least one other of the plurality green display elements, providing a plurality of blue display elements disposed in a third row such that each of the plurality of blue display elements is disposed adjacent to at least one other of the plurality blue display elements, providing a second plurality of green display elements disposed in a fourth row such that each of the second plurality of green display elements is disposed adjacent to at least one other of the second plurality green display elements, wherein the second row is disposed adjacent to, and between, the first row and the third row, and wherein the third row is disposed adjacent to, and between, the second row and the fourth row, and providing a repeating pattern of the first, second, third, and fourth rows of display elements to form an arrangement of display elements of a display. In some implementations, the method can further include configuring a plurality of pixels from the display elements of the display, each pixel in the plurality of pixels including one red display element, a first green display disposed adjacent to the red display element, a second green display element disposed adjacent to the first green display element, and a blue display element disposed adjacent to the second green display element. The method can include configuring a plurality of pixels from the display elements of the display, each pixel in the plurality of pixels including one red display element disposed in the first row, two green display elements disposed in the second row, and one blue display element disposed in the third row. In some implementations, the method includes providing a plurality of red display elements disposed in a fifth row such that each of the display elements in the fifth row are disposed adjacent to at least one other red display element in the fifth row, where the fifth row is adjacent to the fourth row and disposed such that the fourth row is between the third row and the fifth row, configuring a first plurality of display elements of the array to form a first plurality of pixels, each pixel in the first plurality of pixels including one red display element of the first row, a first green display of the second row disposed adjacent to the red display element, a second green display element of the second row disposed adjacent to the first green display element, and a blue display element of the fourth row disposed adjacent to the second green display element, and configuring a second plurality of display elements of the array to form a second plurality of pixels, each pixel in the second plurality of pixels including one blue display element of the third row, a first green display of the fourth row disposed adjacent to the blue display element, a second green display element of the fourth row disposed adjacent to the first green display element, and a red display element of the fifth row disposed adjacent to the second green display element.

Another innovative aspect of the subject matter described in this disclosure can be implemented in a passive matrix display apparatus including a plurality of red display elements disposed in a first row, a plurality of green display elements disposed in the first row, one green display element disposed between each of the plurality of red display elements, a plurality of red display elements disposed in a second row diagonally adjacent to the red display elements in the first row, a plurality of blue display elements disposed in the second row, one blue display element disposed between each of the plurality of red display elements in the second row, a plurality of blue display elements disposed in a third row diagonally adjacent to the blue display elements in the second row, a plurality of green display elements disposed in the third row, one green display element disposed between each of the plurality of blue display elements in the third row, where the second row is adjacent to, and between, the first row and the third row, and wherein the apparatus further comprises a plurality of pixels, each pixel in the plurality of pixels including one red display element, one green display element and one blue display element, and wherein the red, green and blue display elements of each pixel are in two adjacent rows.

Another innovative aspect of the subject matter described in this disclosure can be implemented in a passive matrix display apparatus including a plurality of red display elements disposed in a first row, a plurality of blue display elements disposed in the first row, one blue display element disposed between each of the plurality of red display elements, a plurality of green display elements disposed in a second row adjacent to the first row, a plurality of green display elements disposed in a third row adjacent to the second row, a plurality of red display elements disposed in a fourth row, the fourth row adjacent to the third row, and a plurality of blue display elements disposed in the fourth row, one blue display element disposed between each of the plurality of red display elements. In some implementations, the red elements in the fourth row are aligned with the blue elements in the first row, and the blue elements in the fourth row are aligned with the red elements in the first row.

Another innovative aspect of the subject matter described in this disclosure can be implemented in a passive matrix display apparatus having rows and columns of display elements, the apparatus including a plurality of red display elements disposed in a first row, a plurality of green display elements disposed in the first row, one green display element disposed between each of the plurality of red display elements in the first row; a plurality of blue display elements disposed in a second row arranged adjacent to the first row, a plurality of green display elements disposed in the second row, one green display element disposed between each of the plurality of blue display elements in the second row, a plurality of blue display elements disposed in a third row arranged adjacent to the second row, a plurality of green display elements disposed in the third row, one green display element disposed between each of the plurality of blue display elements in the third row, wherein each of the blue display elements in the third row are aligned with a red display element that is disposed in the first row such that the blue display elements in the third row and the red display elements in the first row are in the same column, a plurality of red display elements disposed in a fourth row arranged adjacent to the third row, a plurality of green display elements disposed in the fourth row, one green display element disposed between each of the plurality of red display elements in the fourth row, wherein each of the red display elements in the fourth row are aligned with a blue display element that is disposed in the second row such that the red display elements in the fourth row and the blue display elements in the second row are in the same column, and a plurality of pixels each having four display elements disposed in a 2×2 arrangement, the plurality of pixels including at least two sets of pixels, wherein one set of pixels each include an adjacent red and green display elements disposed in the first row and an adjacent green and blue display elements disposed in the second row, and a second set of pixels each includes adjacent blue and green display elements disposed in the third row and adjacent green and red display elements disposed in the fourth row.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a plan view depicting pixels in a portion of a display, the pixels having display elements arranged in a triad configuration.

FIG. 10 shows an example of a plan view depicting pixels in a portion of a display, each pixel having display elements arranged in a quad configuration.

FIG. 11 shows an example of a plan view depicting pixels in a portion of a display, each pixel having display elements arranged in a quad configuration with a display element for reflecting green light having an active area smaller than the active area of another green display element.

FIG. 12 shows another example of a plan view of a display depicting pixels in a portion of the display, each pixel having one red, the one blue and two green display elements arranged in a 2×2 quad configuration, where the two green display elements of each pixel are aligned diagonally with each other.

FIG. 13 shows another example of a plan view depicting pixels in a portion of a display, each pixel having display elements arranged in a quad configuration similar to the display shown in FIG. 12, each pixel including a display element for reflecting green light that has a smaller active area than the active area of another green display element in the pixel.

FIG. 14 shows another example of a plan view depicting pixels in a portion of a display, each pixel having display elements arranged in a quad configuration similar to the display shown in FIG. 12, each pixel including two display elements for reflecting green light each which has a smaller active area than a red display element and a blue display element in the pixel.

FIG. 15 shows an example of a plan view depicting pixels in a portion of a display 1500, each pixel having two adjacent green display elements, a red display element, and a blue display element.

FIG. 16 shows an example of a plan view depicting pixels in a portion of a display, each pixel having two adjacent green display elements, a red display element, and a blue display element arranged in the same configuration as illustrated in FIG. 15, the green display elements having a smaller active area than the red and blue display elements.

FIG. 17 shows an example of a plan view depicting pixels in a portion of a display, each pixel having two adjacent green display elements, a red display element, and a blue display element arranged in the same configuration as illustrated in FIG. 15, the green display elements of every other pixel having an active area less than or equal to half of the size of the active area of both the red or blue display element.

FIG. 18 shows an example of a plan view depicting adjacent pixels in a portion of a display 1800, each pixel having a red display element, a blue display element, and two green display elements arranged in a line, the two green display elements each having an active area less than the active area of the red or blue display element where the green display elements for each of the pixels are adjacent to each other.

FIG. 19A shows a schematic illustrating a plan view depicting lines coupled to display elements in a portion of the display 900 illustrated in FIG. 9, having two segment lines disposed between columns of the display elements.

FIG. 19B shows an example of a plan view depicting driving lines coupled to display elements in a portion of the display 1800 illustrated in FIG. 18 having two segment lines disposed between columns of the display elements.

FIG. 19C shows an example of a plan view depicting driving lines coupled to display elements in a portion of a display and having one segment lines disposed between columns of the display elements.

FIGS. 20A and 20B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Electronic and electromechanical displays for computers and mobile devices can include an array of display elements aligned in rows and columns and arranged to form pixels. In a passive display, the display elements in a row of the display are electrically connected such that all of the display elements in the row are exposed to a drive signal that a driver circuit sends to address any of the display elements in the row. Determining an appropriate drive voltage suitable for all the display elements can be difficult if the display elements that are configured to display different colors (for example, red, green or blue) use a different drive voltage amplitude. In implementations described herein, pixel configurations are disclosed that allow a drive line to connect multiple display elements configured to produce the same color. These configurations can then be addressed with the appropriate drive voltage.

Particular implementations of the subject matter described in this disclosure can be implemented to realize one or more of the following potential advantages. Some pixel arrangements used in displays are configured as a 3×3 matrix of red/green/blue stripes data lines. Such arrangements can limit minimum pixel dimensions and thus the maximum achievable pixels per inch (PPI) for displays. In some implementations to address this issue, pixel configurations (or mosaics) can be arranged in 2×2 “quad pixel” configuration, instead of, for example, a 3×3 configuration. Such configurations can be used to increase display panel resolution to 314-362 PPI range. In addition, certain arrangements of a 2×2 quad pixel allow the display elements of all three colors to be connected to individual “COM” or “common” drive lines. As used herein, “COM drive lines” or simply “COM lines” are broad terms that refers to a common signal line on which a drive signal is provided to the common elements along a particular line, or row of display elements. In some implementations, the routing connections are made through a black mask structure, for example, a single layer of a black mask or more than one layer of a black mask structure.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

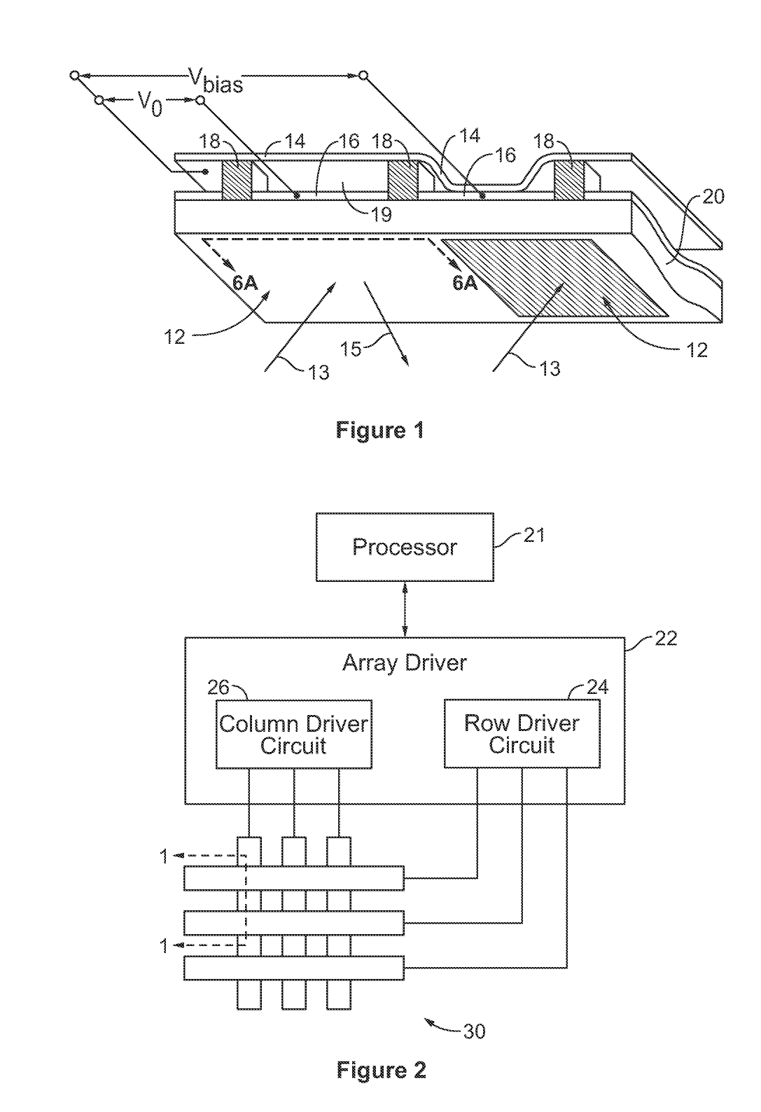

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

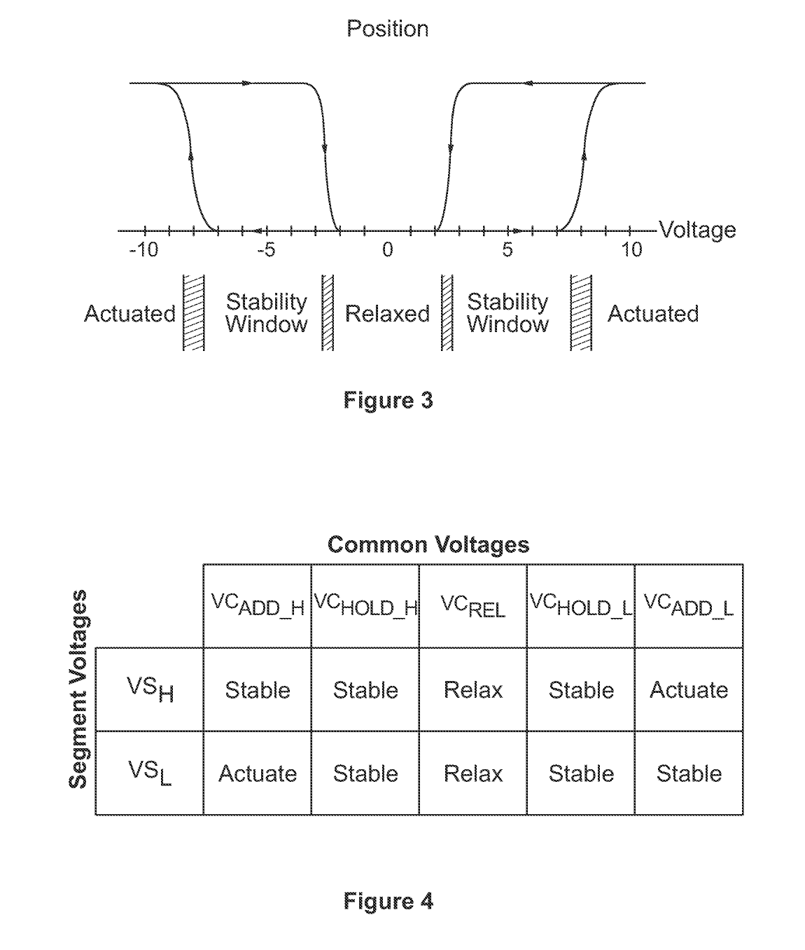

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

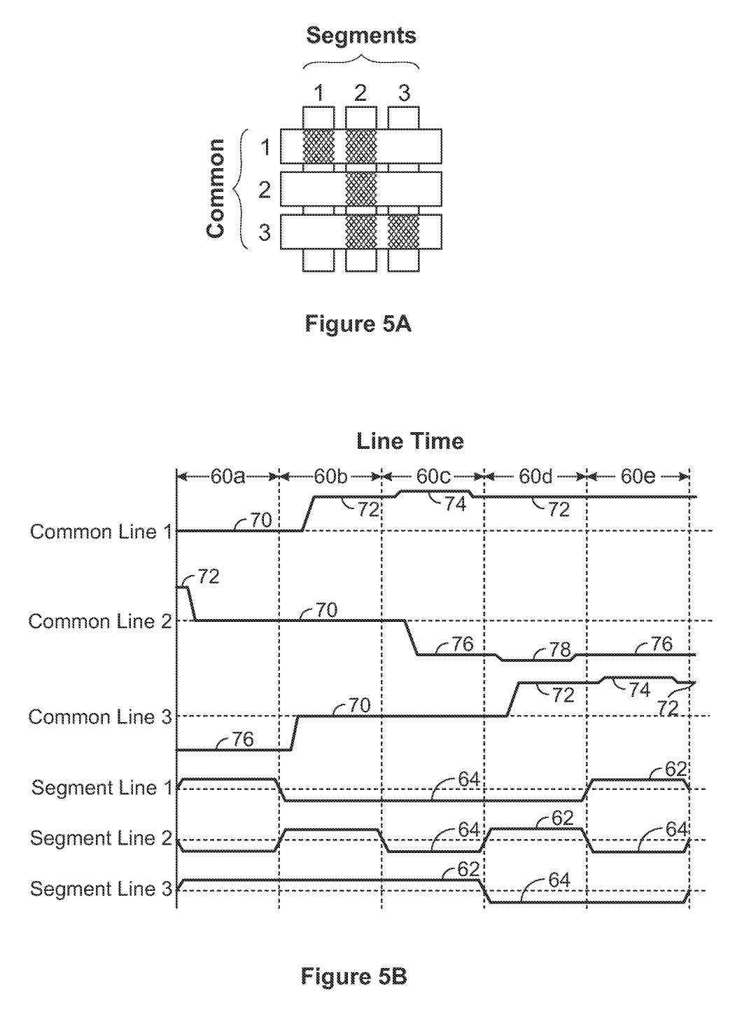

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

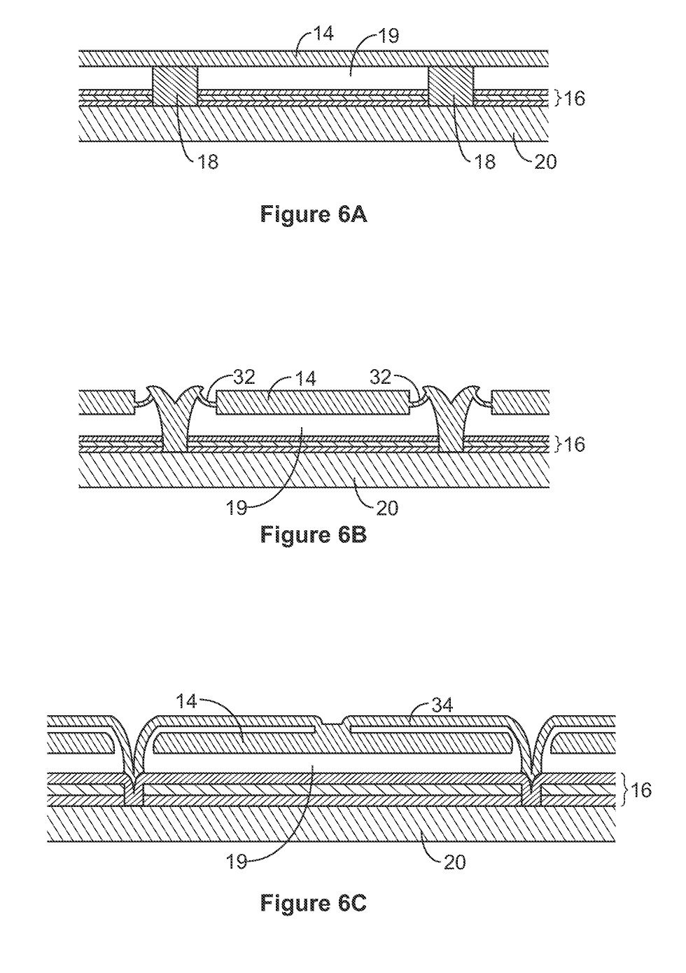

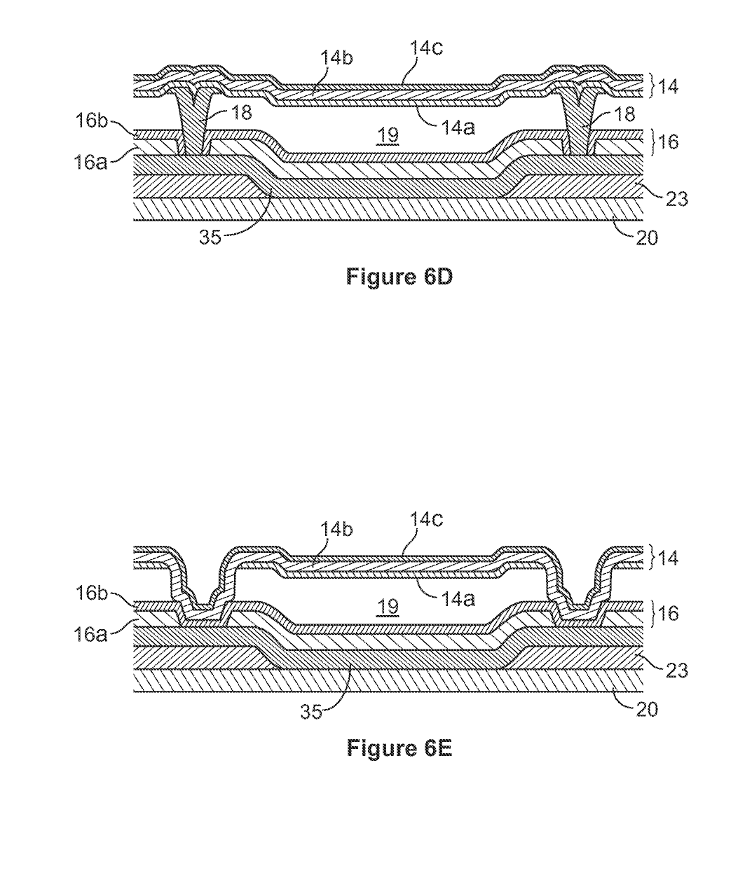

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures.

FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

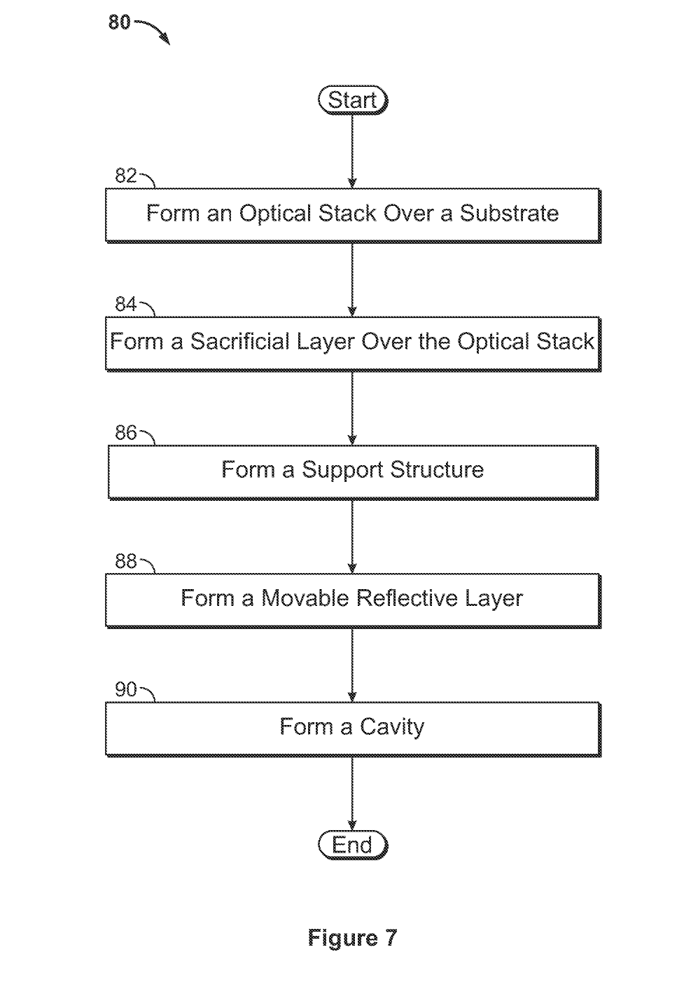

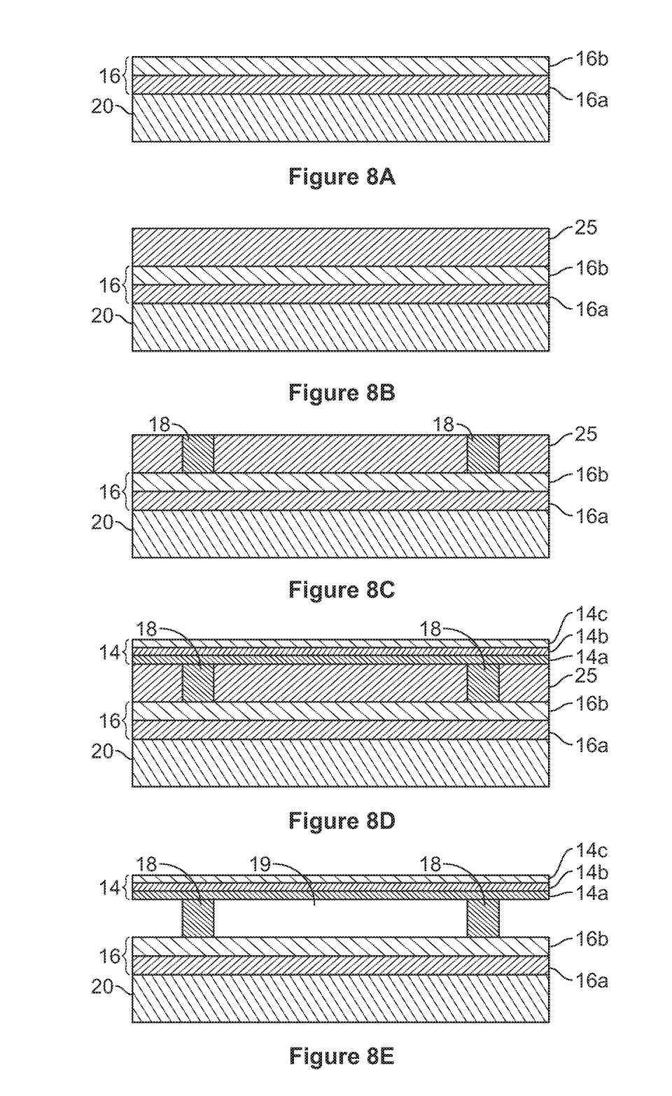

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Some pixel arrangements used in displays are configured as a 3×3 matrix of red/green/blue stripes and most-significant bit/least-significant bit (MSB/LSB) data lines. Such arrangements can limit minimum pixel dimensions and thus the maximum achievable pixels per inch (PPI) for displays. For example, in some implementations, for practical actuation voltages of V_{actuation}<20V, a display element mirror size is physically limited to approximately 35-40 um. This constrains the resolution of the panel to about 211-241 PPI. In some implementations to address this issue, pixel configurations (or mosaics) can be arranged in 2×2 configuration (instead of a 3×3 configuration). Such configurations can be used to increase display panel resolution to 314-362 PPI range.

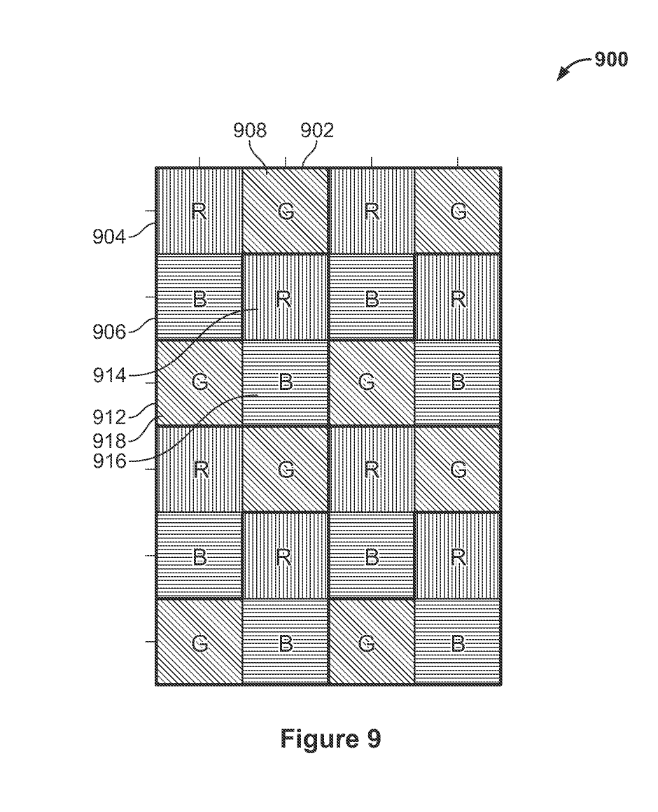

FIGS. 9-20 describe spatial configurations of the pixel mosaics of interferometric modulator devices capable of meeting the requirements of higher resolution electronic devices, for example, smartphones and tablet computers. Such devices can require higher resolution displays to adequately display the information. In some devices, HD720 and WXGA resolution are standard for displays with 3.5″-4″ diagonal. The described pixel configurations can be used to achieve such resolutions. Although the pixel configurations are described with respect to having pixels capable of producing three primary colors red, green and blue (“R/GB” or “RGB”), other pixel configurations are also possible using four colors, for example, red, green, blue and yellow (“R/GB/Y” or “RGBY”). While the pixel implementations described herein have square pixel configurations and the mirror size can be about 35-40 um, other shapes of and sizes of pixels can also be used. Also, such pixel arrangements can be used for display elements other than interferometric display elements. In addition, the arrangements of display elements and pixels can also be used in passive matrix displays and active matrix displays. As used herein, an active matrix display is a broad term that refers to displays where each display element (or pixel or subpixel) has a switchable element to control each display element. A passive matrix display, as used herein, is a broad term that refers to displays where each display element does not have a switchable control element. Features described in relation to an implementation described herein can also be included in other implementations even though they may not be repeated again for each particular implementation.

FIG. 9 shows an example of a plan view depicting pixels in a portion of a display 900, the pixels having display elements arranged in a triad configuration. The red, green and blue display elements are indicated in the display 900 by a “R,” “G” and “B,” respectively. The display 900 includes a plurality of pixels, each having three display elements. For example, representative pixel 902 of the display 900 includes a red display element 904, a blue display element 906 arranged laterally adjacent to the red display element 904, and a green display element 908 arranged laterally adjacent to the red display element 904 and diagonally adjacent to the blue display element 906 forming a “90 degree angle” triad pixel 902. As used herein, laterally adjacent refers to an arrangement where a side of one display element is disposed next to a side of another display element. In other words, where one display element is arranged adjacent and beside another display element and not disposed diagonally adjacent. Another representative pixel 912 of the display 900 includes a red display element 914, a blue display element 916 arranged laterally adjacent to the red display element 914, and a green display element 918 arranged laterally adjacent to the blue display element 916 and diagonally adjacent to the red display element 914 to also form a “90 degree angle” triad pixel 912. In this implementation, the two adjacent pixels 902 and 912 are combined in such a way that they form a rectangle having 2×3 pixels display elements. As such, given that two pixels may form a rectangle having a 2×3 arrangement, in a triad configuration, a single pixel may be considered to have a 2×1.5 arrangement.

In the implementation shown in FIG. 9, the number of green display elements is equal to the number of red and/or blue display elements. However, in some implementations, the number of green display elements may be greater than the number of red and/or blue display elements. For example, in some implementations of spatial configurations of display devices include display devices having pixels with two equally sized green display elements (e.g., mirrors for IMOD display elements) that are the same size as the other display elements in the pixel. Such implementations of IMODs have green mirrors with the maximum achievable fill factor, and this can result in a higher brightness due to the larger green area than for configurations with reduced size green display elements/mirrors. IMOD implementations having two large green display elements may also have more visible dither artifacts than implementations with either one or both display elements configured to have a smaller active, or color contributing, surface area. One benefit for having green display elements with the same active area as red and/or blue is that the overall display will be brighter than implementations where parts of the green display elements are black masked to reduce the active area of the green display elements. However, a desirable or standardized white point, which is a combination of RGB light provided by the pixel, may be more difficult to achieve because the overall green area is larger than either the red and blue display elements.

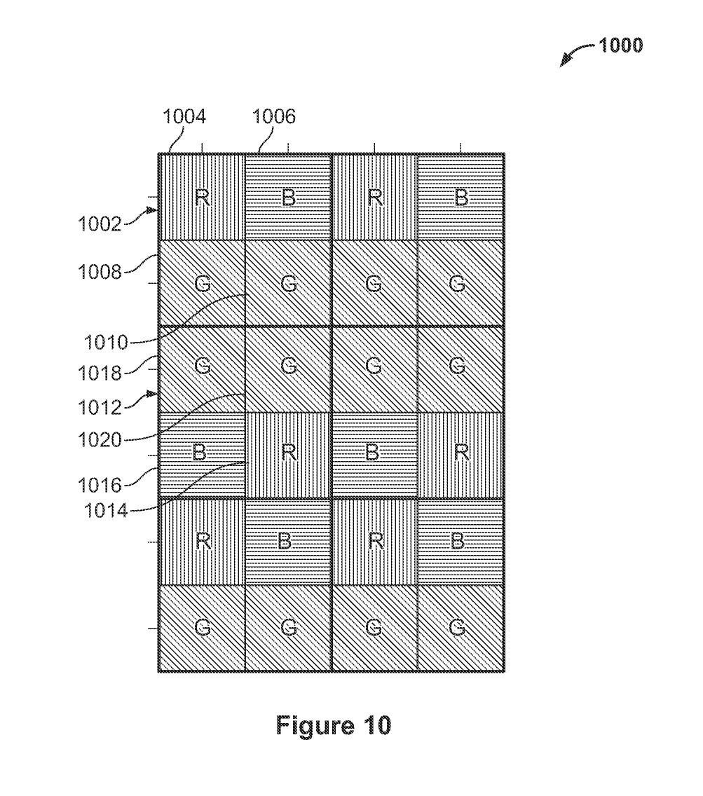

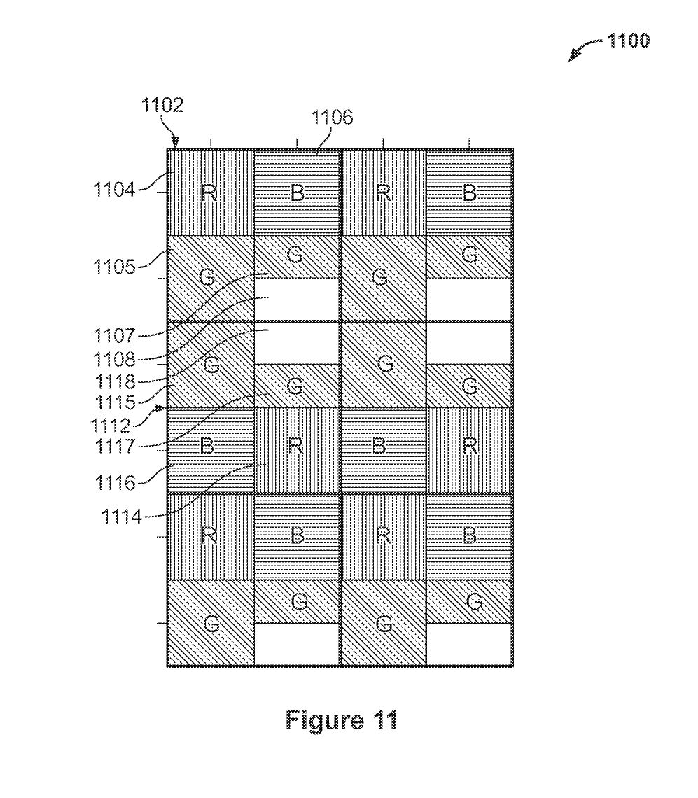

FIG. 10 shows an example of a plan view depicting pixels in a portion of a display 1000, each pixel having display elements arranged in a quad configuration. The red, green and blue display elements are indicated in the display 1000 by a “R,” “G” and “B,” respectively. Pixels 1002 and 1012 are representative pixels of the display 1000. Pixel 1002 has a red display element 1004, a blue display element 1006 disposed laterally to the red display element 1004, and two green display elements 1008 and 1010 disposed laterally adjacent to each other. Green display element 1008 is also disposed laterally adjacent to the red display element 1004 and diagonally adjacent to the blue display element 1006. Green display element 1010 is disposed laterally adjacent to the blue display element 1004 and diagonally adjacent to the red display element 1004. Pixel 1012 has a red display element 1014, a blue display element 1016 disposed laterally to the red display element 1014, and two green display elements 1018 and 1020 disposed laterally adjacent to each other. Green display element 1020 is also disposed laterally adjacent to the red display element 1014 and diagonally adjacent to the blue display element 1016. Green display element 1018 is also disposed laterally adjacent to the blue display element 1014 and diagonally adjacent to the red display element 1014. In the illustrated implementation, all of the display elements of display 1000 are the same size.

As illustrated in FIG. 10, the green display elements 1008 and 1010 are of equal size and equal to the size of the red display element 1002 and the blue display element 1006. In such implementations described herein, such pixels can have a maximum achievable fill factor, and a higher brightness due to the relatively large percentage (50%) of the green display element display area. Also, higher brightness levels can be achieved due to the larger percentage of the green display element display area of each pixel. In such pixel arrangements, the same V_{actuation} can be used for the two green display elements in each pixel. In some cases, with this configuration white point (which is a combination of R/G/B) can be more difficult to achieve due to the overall relatively large percentage of the green display area of each pixel.

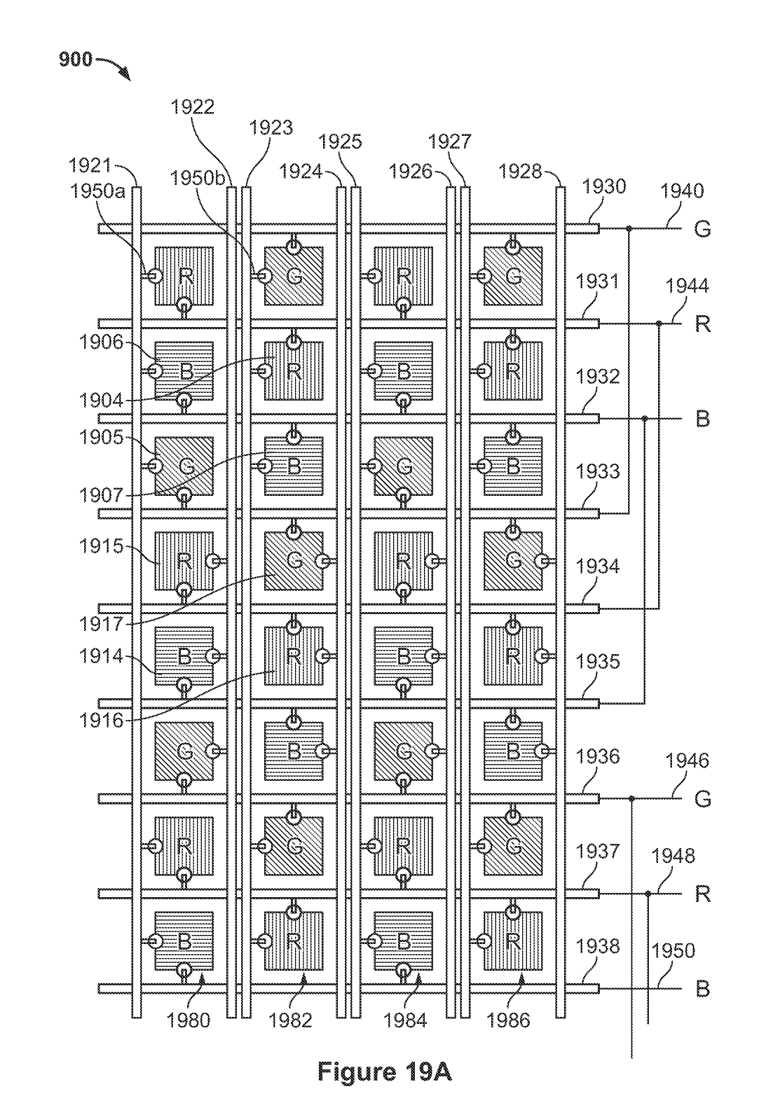

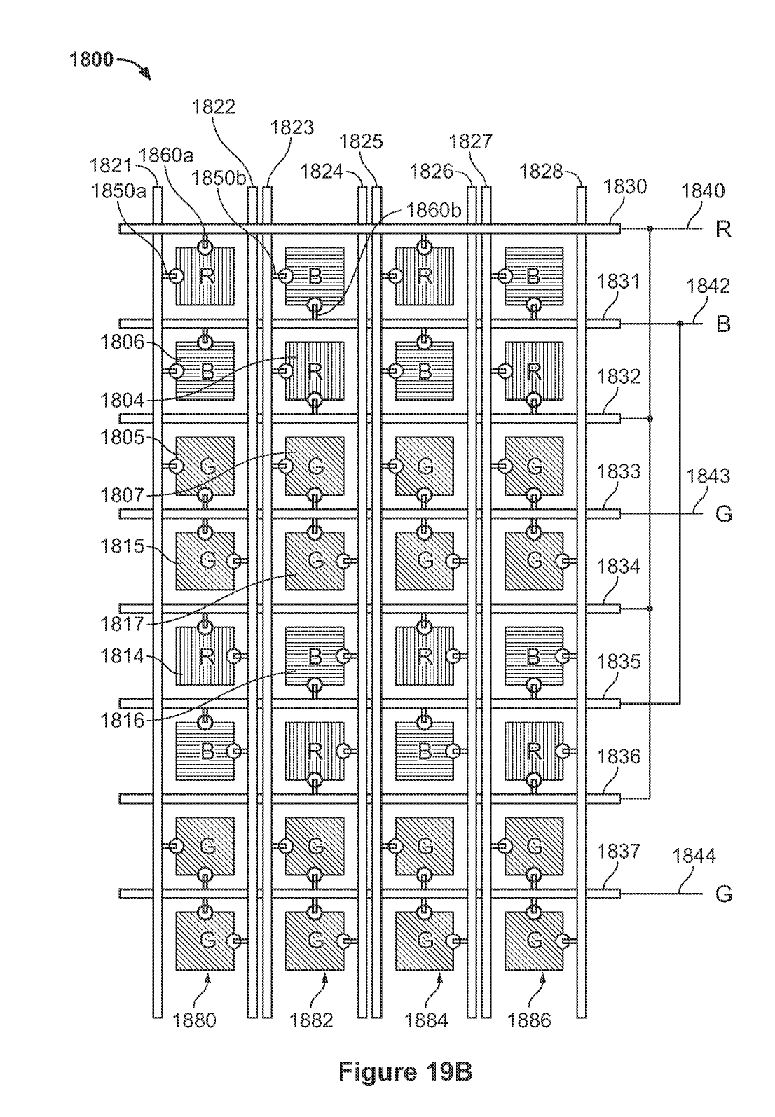

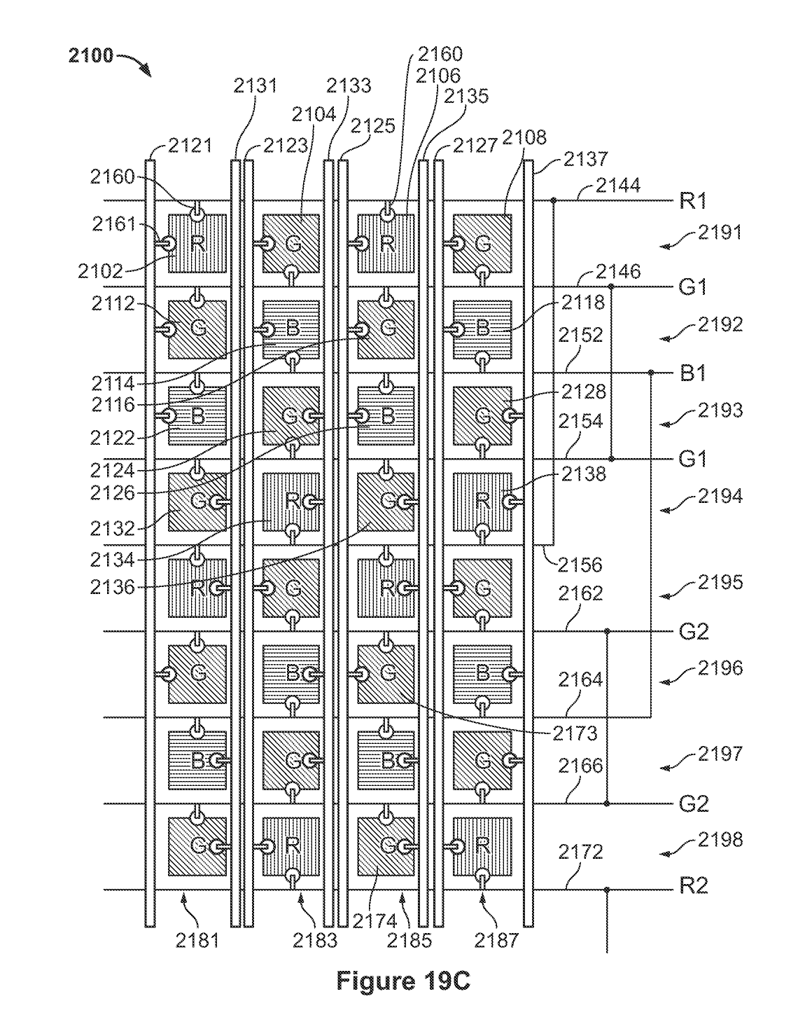

In the pixel arrangement of FIG. 10, the position of the green display elements of two adjacent pixels are flipped so they align along together to form a dual stripe of green display elements. In other words, the green display elements 1008 and 1010 of pixel 1002 are disposed adjacent to the green display elements 1018 and 1020 of pixel 1012. One advantage of this arrangement is that green display elements 1008 and 1010 of pixel 1002 and green display elements 1018 and 1020 of pixel 1012 can both be more easily addressed with a single COM (or drive) line than in a design where rows of green display elements of different pixels are not adjacent. Another advantage of this arrangement is that rows of display elements for each of the three colors R/G/B could be connected to individual COM lines particular to a given color. Note that red and blue color display elements can be driven with different voltages. This is further described in connection with FIGS. 19B and 19C. In some such implementations, the drive lines are connected through a single layer black mask routing.

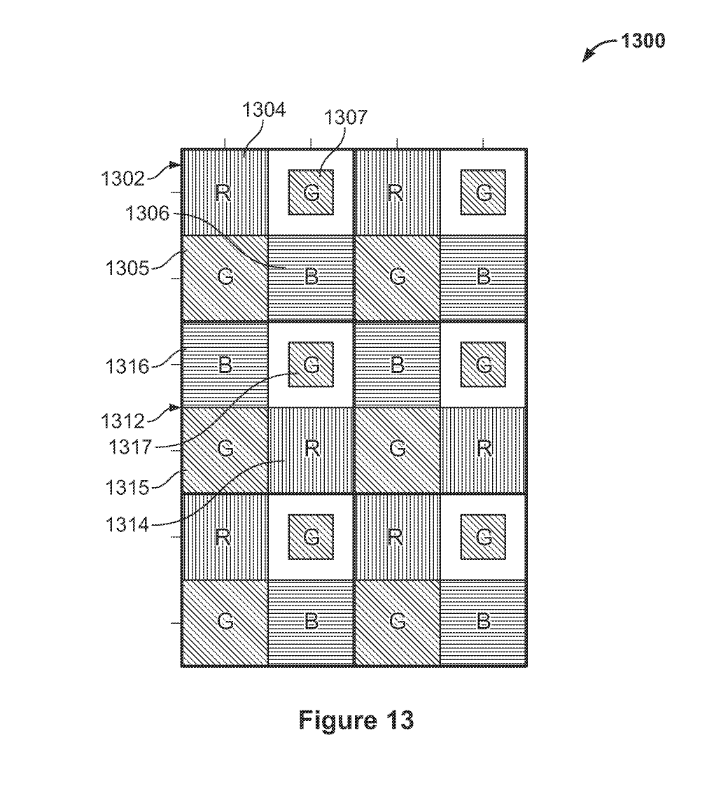

Some implementations of spatial configurations of display devices include display devices having pixels with binary weighted mirrors. In such implementations, the modulated areas or fill factors of two green display elements (also sometimes referred to as the movable reflective layers or simply as “mirrors”) can have a ratio of approximately 2:1, the difference being achieved by adjusting the black mask area in one or two of the green display elements (i.e, sub-pixels). For example, if a pixel has two green display elements, a first green display element may be substantially the same size as the red and the blue display elements, while a second green display element may be a fraction of the size of the first green display element, for example in a binary weighted implementation, the size of the second green display element may be about half of the size of the first green display element. This implementation allows four gray levels to be rendered in green rather than the three available if the mirrors have equal fill factors. These implementations can have lower brightness due to lower fill factor of the green mirrors, but the brightness of the display is not affected significantly. In addition, such configurations can produce a minimal number of dither artifacts, when compared to other configurations. This is because dither artifacts can depend on the minimum mirror size, accordingly the half green mirror will have less visible dither artifacts. In such configurations, white point is more easily achieved by combining light reflected from the RGB display elements compared to designs in which the size of both green display elements are equal to each other and equal to one, the other, or both of the red and green display elements. The “distance” to a desired white point can be controlled by the overall area of the two green mirrors in relation to the size of the red mirror and the blue mirror. Factors contributing to a good white point include the relative size of the total green active area compared to the red and blue active areas in a given pixel. In an implementation where each pixel has two greens and only one red and/or blue, adjusting the white point may include adjusting the size of one or both of the green display elements. However, reducing the size of one or both of the green display elements by masking parts of one or both display elements can result in lower overall brightness of the display. In some implementations, different sized active areas for different green display elements may mean that the relatively large and relatively small mirrored green display elements have different actuation voltages. Two examples where one green display element in a given pixel is smaller than the other green display element are illustrated in FIGS. 11 and 13.

FIG. 11 shows an example of a plan view depicting pixels in a portion of a display 1100, each pixel having display elements arranged in a quad configuration with a display element for reflecting green light having an active area smaller than the active area of another green display element. The red, green and blue display elements are indicated in the display 1100 by a “R,” “G” and “B,” respectively. The display 1100 includes a plurality of pixels, including pixels 1102 and 1112, which are representative of the arrangement of the pixels and the display elements in display 1100. Pixel 1102 includes a red display element 1104, a blue display element 1106 disposed laterally adjacent to the red display element 1104, and a first green display element 1105 disposed laterally adjacent to the red display element 1104 and diagonally adjacent to the blue display element 1106.

The size of the display area (i.e., the “active area”) of the red, green and blue display elements 1104, 1105 and 1106 display elements are configured as square-shaped and are the same size. The pixel 1102 also includes a second green display element 1107 disposed laterally adjacent to the blue display element 1106 and the first green display element 1105, and diagonally adjacent to the red display element 1104. The active area of the second green display element 1107 is smaller then the red, green and blue display elements 1104, 1105 and 1106 display elements. In some implementations, the second green display element is the same size as the other display elements in pixel 1102, but includes a masked portion 1108 which can be configured to appear dark or black, thereby decreasing the active area of the second display element 1107. In some implementations, the second green display element 1107 is fabricated as a smaller display element. In some implementations, including as illustrated in FIG. 11, the active area of the second green display element 1107 is half the size of the red, green and blue display elements 1104, 1105 and 1106. As illustrated, the green display elements 1107 and 1117 are rectangular shaped, but can also be square shaped.

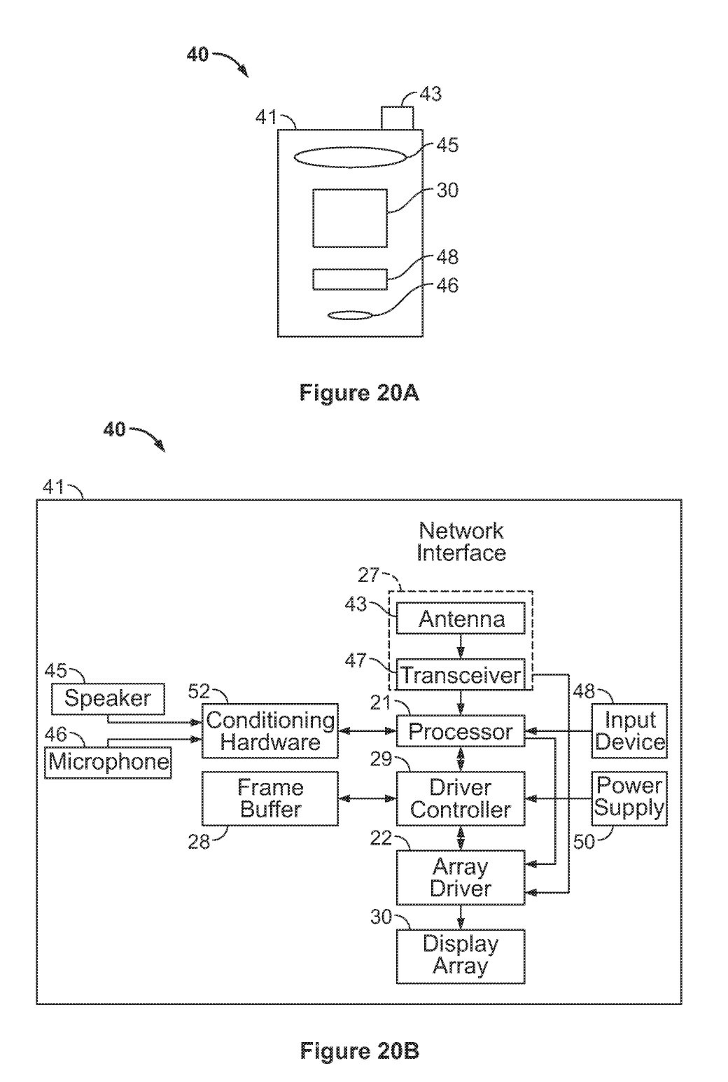

Pixel 1112 has a similar arrangement of display elements, and is oriented such that it is flipped relative to pixel 1102. Accordingly, the first and second green display elements 1105 and 1107 of pixel 1102 and the first and second green display elements 1115 and 1117 are adjacent and together form a dual stripe of green display elements. One advantage of this arrangement is that the red, green and blue display elements can each be connected to dedicated COM lines for each color, as the voltage needed to drive each color can be different and it is useful to drive display elements of a single color together with one COM line. This is further described in connection with FIGS. 19 and 20. Specifically, pixel 1112 includes a blue display element 1116, a red display element 1114 disposed laterally adjacent to the blue display element 1116, and a first green display element 1115 disposed laterally adjacent to the blue display element 1116 and diagonally adjacent to the red display element 1114.

In this implementation, the size of the display area (i.e., the “active area”) of the red, green and blue display elements 1114, 1115 and 1116 display elements are configured as square-shaped and are the same size. The pixel 1112 also includes a second green display element 1117 disposed laterally adjacent to the red display element 1114 and the first green display element 1115, and diagonally adjacent to the blue display element 1116. The active area of the second green display element 1117 is smaller then the red, green and blue display elements 1114, 1115 and 1116 display elements. In some implementations, the second green display element is the same size as the other display elements in pixel 1112, but includes a masked portion 1118 which can be configured to appear dark or black, thereby decreasing the active area of the second display element 1117. In some implementations, the second green display element 1117 is fabricated as a smaller display element. In some implementations, including as illustrated in FIG. 11, the active area of the second green display element 1117 is half the size of the red, green and blue display elements 1114, 1115 and 1116 display elements, and it is also rectangular-shaped. The first green display element 1115 of pixel 1112 is disposed adjacent to the first green display 1105 of pixel of 1112, and the masked portion 118 of pixel 1112 is disposed laterally adjacent to the masked portion 1108 of the pixel 1102.

In the implementation illustrated in FIG. 11, for the pixel 1102 the ratio of the active area of the green display element 1105 to each of the active areas of green display element 1107, red display element 1104, and blue display element 1106 can be approximately 2:1. In some implementations, the difference between the active areas of the display elements can be being achieved by using a black mask on the green display element 1107 to mask a portion of the active area of the smaller active area display element. This allows four illumination levels to be rendered by the green display elements 1105 and 1107, rather than the three if the green display elements 1105 and 1107 have equal active areas. For example, the four illumination levels can be described as zero G, ½ G, G and 1½ G. In such configurations, each pixel 1102 of the display 1100 provides a lower maximum brightness due to a lower total active area of the display elements 1104, 1106, 1105 and 1107 when compared to a display where both green display elements are equal to the red and blue display elements. However, such implementations can also produce less green visible dither artifacts as such artifacts are related to the size of the minimum active area. In addition, a white point can be more easily achieved by combining the red, green and blue display elements when compared to combining red, green and blue display elements, all of equal number and size. In some implementations, the ratio of the active area of a first green display element (such as green display element 1105) and a second green display element (such as green display element 1107) can range between 1:1 to 1:2. Although illustrated with smaller green display element 1107 of pixel 1102 laterally adjacent to smaller green display element 1117 of pixel 1112, it is understood that, for example, green display element 1115 and green display element 1117 may be switched. In such an implementation, smaller green display element 1107 of pixel 1102 is diagonally adjacent to smaller green display element 1117 of pixel 1112.

The distance to the white point can be controlled by the overall area of the two green mirrors. For example, in the triad implementation of FIG. 9, in implementations where all of the red, green, and blue display elements are of equal size, green will cover about ⅓ (33%) of the total pixel area. In implementations, like FIG. 11, where a pixel can have more than one green display element and/or one or more green display elements has a size that is different, for example smaller, than the size of one of the red and blue display elements, the percentage of the green active area compared to the total active area of all display elements in a given pixel may range from 33% to 45%, for example 33% to 40%. The brightness of the display 1100 can be affected using pixels with a smaller second green display element 1107. However, if the ratio of the active area of the first green display element to the second green display element ranges between 1:1 to 2:1, and the total active area of the green display elements compared to the total active area of a given pixel is between 33% to 45%, a decrease in brightness may be worth the improvement in dither visibility and/or the improvement of the white point (when compared to a display where the total green element(s) active area is substantially the same size as the active area of each of the red and blue display elements). Selecting the size of the green display elements can be characterized as a tradeoff between brightness and white point. With two equal sized green display elements, a higher brightness can be achieved, but the “white” color produced can be perceived as being too green in tint. When the total active area of the green display elements is less than half of the total active area of the pixel, a “better” white point can be achieved (in other words, more “white”), but the light reflected is slightly less bright than an arrangement with two equal sized greens.

In some implementations, the first and second green display elements 1105 and 1107 have different actuation voltages. However, in implementations where the first and second green display elements 1105 and 1107 are the same size but have different active areas due to the second display element 1107 being masked by a black mask, the actuation voltages may be the same.

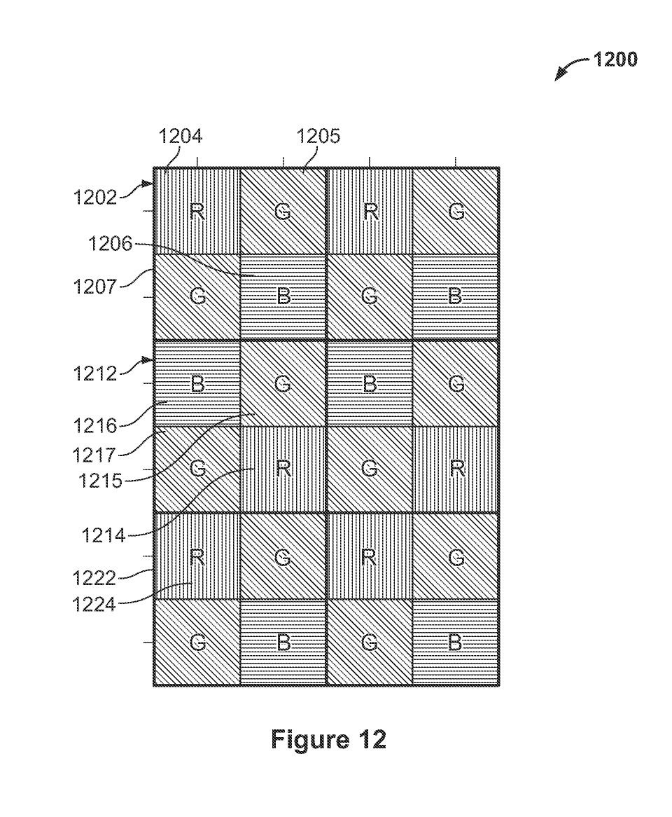

FIG. 12 shows another example of a plan view of a display 1200 depicting pixels in a portion of the display 1200, each pixel having one red, the one blue and two green display elements arranged in a 2×2 quad configuration, where the two green display elements of each pixel are aligned diagonally with each other. The red, green and blue display elements are indicated in the display 1200 by a “R,” “G” and “B,” respectively. In the display 1200, the arrangement of display elements within a pixel is different for the pixels in adjacent rows (a “row” here used to refer to the pixels arranged along a horizontal direction relative to FIG. 12). For example, pixel 1202 includes a 2×2 arrangement of display elements where the first row of display elements is R and G and the second row of display elements is G and B (that is, the display elements are arranged left to right in two rows R, G, G and B). Pixel 1212, disposed adjacent to and below pixel 1202 (relative to the orientation of FIG. 12), includes a 2×2 arrangement of display elements where the first row of display elements is B and G and the second row of display elements is G and R (that is, the display elements are arranged left to right in two rows B, G, G and R). For example, in such a staggered quad configuration, red and blue display elements are switched in the pixel adjacent along a column so as to allow straightforward addressing of pixels of a single color using a single row COM drive line (or electrode). For example, green display elements in pixel 1202 can be easily connected to a signal COM line disposed between green display element 1205 and 1207. Similarly, blue display elements from pixel 1202 and 1212 can be connected to a single COM line disposed between blue display elements 1206 and 1216. Also, red display elements from pixels 1212 and 1222 can be connected to a single COM line disposed between red display elements 1214 and 1224. In this way, a single COM line extending across an entire row of the display can be connected to display elements of the same color which zig-zag on opposite sides of the COM line as one moved across the line. In such a configuration, the colors of the display elements in the display 1200 form a zig-zag pattern along rows of the display.

The display 1200 includes (representative) pixels 1202 and 1212. Pixel 1202 includes a red display element 1204, two green display elements 1205 and 1207 disposed laterally adjacent to the red display element 1204, and a blue display element 1206 disposed laterally adjacent to the two green display elements 1205 and 1207 and diagonally adjacent to the red display element 1204. As illustrated, the display elements 1204, 1205, 1206 and 1207 have the same size active area. Pixel 1212 includes a red display element 1214, two green display elements 1215 and 1217 disposed laterally adjacent to the red display element 1214, and a blue display element 1216 disposed laterally adjacent to the two green display elements 1215 and 1217 and diagonally adjacent to the red display element 1214. In other words, in adjacent pixels along one direction of the display (in this implementation, a vertical orientation with respect to the orientation of FIG. 12) the positions of the red and blue display elements within the pixels are swapped. In such implementations, all of the display elements can be driven with separate, dedicated COM (drive) lines for a particular color as described above. Such pixel configurations also support multi-line addressing.

As illustrated in FIG. 12, the green display elements are of equal size, and are equal to the size of the red display element 1202 and the blue display element 1206. This can allow the pixels of the display 1200 to have a maximum achievable fill factor, and a higher brightness due to the relatively large percentage (50%) of the green display element display area. Also, higher brightness levels can be achieved due to the larger percentage of the green display element display area of each pixel. In such pixel arrangements, the same V_{actuation} can be used for the two green display elements in each pixel. In some cases, with this configuration white point (which is a combination of R/G/B) can be more difficult to achieve due to the overall relatively large percentage of the green display area of each pixel.

FIG. 13 shows another example of a plan view depicting pixels in a portion of a display 1300, each pixel having display elements arranged in a quad configuration similar to the display 1200 shown in FIG. 12, each pixel including a display element for reflecting green light that has a smaller active area than the active area of another green display element in the pixel. The red, green and blue display elements are indicated in the display 1300 by a “R,” “G” and “B,” respectively.

The display 1300 includes (representative) pixels 1302 and 1312. Pixel 1302 includes a red display element 1304, a first and second green display elements 1305 and 1307 disposed laterally adjacent to the red display element 1304, and a blue display element 1306 disposed laterally adjacent to the two green display elements 1305 and 1307 and diagonally adjacent to the red display element 1304. The red, first green and blue display elements 1304, 1305 and 1306 have the same size active area. The second green display element 1307 has an active area that is smaller than the active area of the red, first green and blue display elements 1304, 1305 and 1306. Pixel 1312 includes a red display element 1314, a first and second green display elements 1315 and 1317 disposed laterally adjacent to the red display element 1314, and a blue display element 1316 disposed laterally adjacent to the two green display elements 1315 and 1317 and diagonally adjacent to the red display element 1314. The red, first green and blue display elements 1314, 1315 and 1316 have the same size active area. The second green display element 1317 has an active area that is smaller than the active area of the red, first green and blue display elements 1314, 1315 and 1316.

As illustrated in FIG. 13, pixels 1302 and 1312 have similar arrangements of pixel elements, but the pixels 1302 and 1312 are aligned differently relative to each other. For example, along one direction (the vertical direction as depicted in the leftmost column of display elements in FIG. 13), the display elements are staggered pixel 1302 to pixel 1312, such that display elements of adjacent pixels are in a different arrangement. Specifically, the pixel 1302 is depicted with in a 2×2 display element arrangement with red and second green display elements 1304 and 1305 in a first row and first green and blue display elements 1307 and 1306 in a second row. Pixel 1312 disposed directly adjacent to pixel 1302 (shown in FIG. 13 as aligned below pixel 1302) is also depicted in a 2×2 display element arrangement. However, the first row of pixel 1312 includes the blue and second green display elements 1316 and 1317, and the second row of pixel 1312 includes the first green and red display elements 1315 and 1314. In other words, in adjacent pixels along one direction of the display the positions of the red and blue display elements are swapped. In such implementations, the display elements for each color can be driven with separate, dedicated common (“COM”) drive lines for each color.

In the implementation illustrated in FIG. 13, the modulated areas or fill factors of the first and second green display elements 1305 and 1307 in the pixel 1302 have a ratio of approximately 2:1, the difference being achieved by adjusting the black mask area of the second green display element 1307. This allows four illumination levels to be rendered by the green display elements 1305 and 1307, rather than the three if the green display elements 1305 and 1307 have equal active areas. In such configurations, each pixel of the display 1300 provides a lower maximum brightness due to a lower total reflective active area of the display elements compared to an implementation where all of the four display elements in a pixel have the same large active area. However, implementations having pixels with a smaller green display element can also produce less green visible dither artifacts as such artifacts are related to the size of the minimum active area. In addition, a white point can be more easily achieved by combining the red, green and blue display elements compared to an implementation with two green display elements being of equal size to the red and blue display elements such that the total active area of the green display elements is about half of the total active area of a given pixel. The distance to the white point can be controlled by the overall area of the two green mirrors such that the overall area of the two green mirrors is less than half, for example, between 30% and 45%.

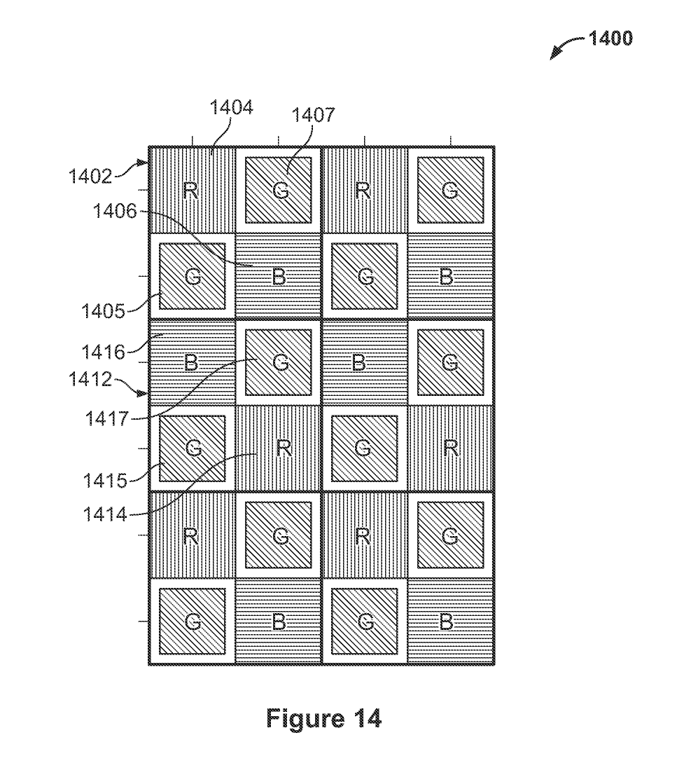

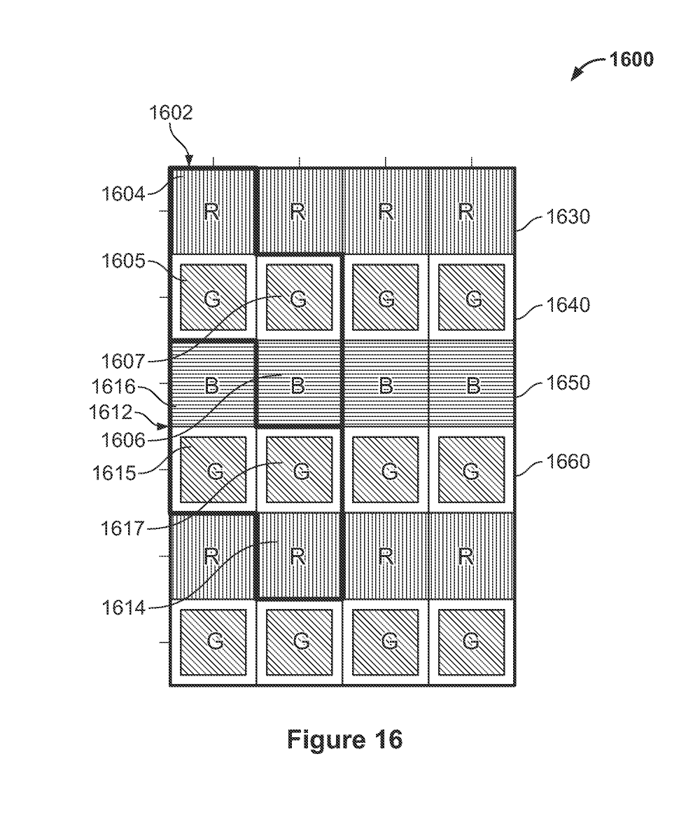

Some implementations of spatial configurations of display devices include display devices having pixels with display elements, or subpixels, that have two equal area “small” green display areas (e.g., mirrors). In other words, each pixel has two display elements that can emit or reflect green light, and the two green display elements are of equal size to each other but smaller than the other display elements in the pixel configuration. In such an implementation, to total active area of the two green mirrors can be between 30% and 45% of the total pixel area, with the total active area of the green mirrors being equally divided between both mirrors. The two green mirrors can be covered by larger black mask to make the fill-factor smaller than the red and blue mirrors in the same pixel. In some implementations, the overall fill factor of the two smaller green mirrors can be equal to the average fill factor of a full size green mirror and a half green mirror. The diminished green display element size (lower fill factor) can cause brightness of the pixel to be lower than if one or both of the green display elements were larger (For example, equal the size of the other display elements). In such implementations, a white point may be more easily achieved compared to implementations where both green display elements are of equal size to the red and blue display elements. The distance to the white point can be controlled by the overall area of the two green mirrors. In these configurations having two small green display elements (or mirrors), the dither artifact visibility is at an intermediate level, between the binary weighted and equal area large mirror designs. Dither artifacts can depend on the minimum mirror size. Accordingly, displays having the display elements including a smaller green mirror may have less visible dither artifacts compared to the full green mirror, but may exhibit more visible artifacts compared to those displays incorporating pixel configurations having a half green mirror. Two examples of such implementations are illustrated in FIGS. 14 and 16.

FIG. 14 shows another example of a plan view depicting pixels in a portion of a display 1400, each pixel having display elements arranged in a quad configuration similar to the display shown in FIGS. 12 and 13, each pixel including two display elements for reflecting green light each which has a smaller active area than a red display element and a blue display element in the pixel. The red, green and blue display elements are indicated in the display 1400 by a “R,” “G” and “B,” respectively.

As shown in FIG. 14, the display 1400 includes (representative) pixels 1402 and 1412. Pixel 1402 includes a red display element 1404, a first and second green display elements 1405 and 1407 disposed laterally adjacent to the red display element 1404, and a blue display element 1406 disposed laterally adjacent to the two green display elements 1405 and 1407 and diagonally adjacent to the red display element 1404. The red and blue display elements 1404 and 1406 have the same size active area. The first and second green display elements 1405 and 1407 have active areas that are smaller than the active areas of the red and blue display elements 1404 and 1406. In this implementation, the first and second green display elements 1405 and 1407 have active areas that are the same size. Pixel 1412 includes a red display element 1414, a first and second green display elements 1415 and 1417 disposed laterally adjacent to the red display element 1414, and a blue display element 1416 disposed laterally adjacent to the two green display elements 1415 and 1417 and diagonally adjacent to the red display element 1414. The red and blue display elements 1414 and 1416 have the same size active area. The first and second green display elements 1415 and 1417 have active areas that are smaller than the active areas of the red and blue display elements 1404 and 1406. In this implementation, the first and second green display elements 1405 and 1407 have active areas that are the same size.

The location of pixels (e.g., pixels 1402 and 1412) and their corresponding display elements illustrated in FIG. 14 are arranged in the same relative orientation as the pixels and display elements illustrated in FIG. 12. In such implementations, the display elements for each color can be driven with separate, dedicated COM (drive) lines for a single color. Also, the actuation voltages for the smaller green display elements may be the same. The two green display elements in each pixel may be covered by a larger black mask such that they have a smaller fill factor, or effective active area. Having the smaller fill factor may result in a lower brightness level as compared to a quad pixel with all of the display elements having the same large active area. However, in such implementations, a desired white point may be easier to achieve by combining light reflected from the four elements, the red, green and blue display elements when the total contribution of the reflective green display elements is below half. For example, the distance to the white point can be controlled by the overall area of the two green mirrors, as discussed above. The visibility of dither artifacts, for the implementation of FIG. 14 is “intermediate,” that is, between the binary weighted (for example, shown in FIG. 13) and equal sized large active area designs (for example, shown in FIG. 12). The visibility of “green” dither artifacts is related to the minimum active area size of the green display elements. In other words, an implementation with two equal, but medium-sized active area green display elements can have less visible “green” dither artifacts compared to an implementation with two equal, but relatively large active area green display elements. However, an implementation with two equal, but medium-sized active area green display elements can have more visible “green” dither artifacts when compared to an implementation having one large and one small active area green display elements, as illustrated in FIGS. 11 and 13.

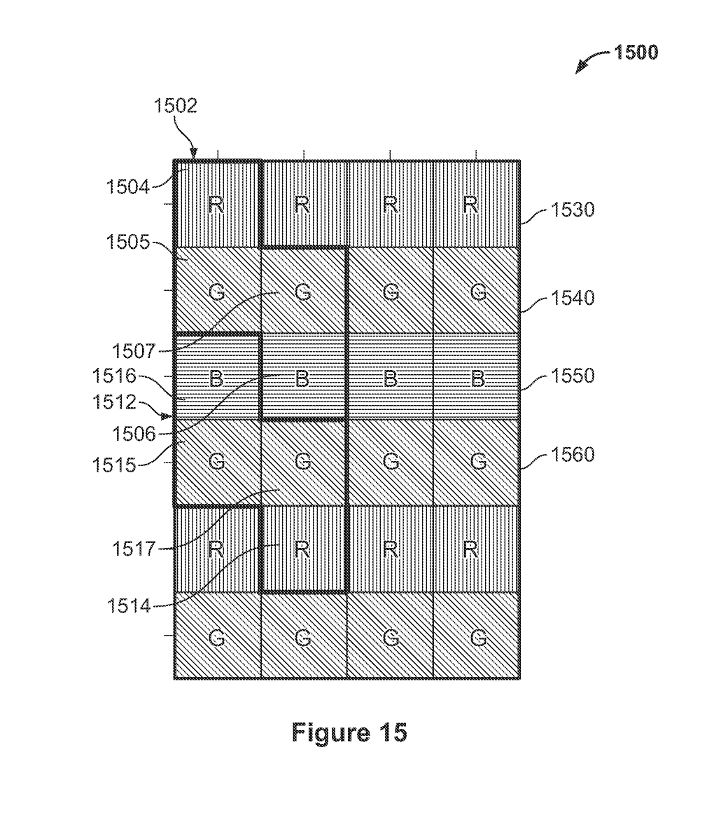

FIG. 15 shows an example of a plan view depicting pixels in a portion of a display 1500, each pixel having two adjacent green display elements, a red display element, and a blue display element. In this implementation, the red and blue display element each disposed laterally adjacent to a different one of the two green display elements, and diagonally adjacent to the other green display, and such that the red and blue display elements within a pixel are neither disposed laterally adjacent nor diagonally adjacent to each other. In other words, in a given pixel, the red and blue display elements are disposed diagonal to each other across a row of green display elements. The red, green and blue display elements are indicated in the display 1500 by a “R,” “G” and “B,” respectively.

As shown in FIG. 15, the display 1500 includes (representative) pixels 1502 and 1512. Directional references stated below refer to the relative orientation of the portion of the display 1500 depicted in FIG. 15. Pixel 1502 includes a red display element 1504, a first green display element 1505, a second green display element 1507, and a blue display element 1506. The first green display element 1505 is disposed laterally adjacent to and below the red display element 1504. The second green display element 1507 is disposed laterally adjacent to and beside the first green display element 1505 such that the first and second green display elements 1505 and 1507 are disposed in the same row. The blue display element 1506 is disposed laterally adjacent to and below the second green display element 1507. Pixel 1512 includes a red display element 1514, a first green display element 1515, a second green display element 1517, and a blue display element 1516. The blue display element 1516 is disposed laterally adjacent to and above the first green display element 1515, and laterally adjacent to and beside the blue display element 1506 of pixel 1502. The first green display element 1515 is disposed laterally adjacent to and below the blue display element 1516. The second green display element 1517 is disposed laterally adjacent to and beside the first green display element 1515 such that the first and second green display elements 1515 and 1517 are disposed in the same row. The red display element 1514 is disposed laterally adjacent to and below the second green display element 1517. Such an arrangement of pixels 1502 and 1512 with the described display element arrangements can be referred to herein as a “shifted quad pixel.”

As illustrated in FIG. 15, the display elements are arranged such that the display elements for each color are aligned laterally adjacent in a row, or “stripe.” For example, a stripe of red display elements 1530, a stripe of green display elements 1540, a stripe of blue display elements 1550, and a stripe of green display elements 1560, and this pattern can repeat throughout the display, the pattern being an “RGBG” pattern. One advantage of the shifted quad pixel implementation is that it allows COM (drive) lines to be connected to a row of display elements that are configured to produce the same color, for example, a row of green display elements.

FIG. 16 shows an example of a plan view depicting pixels in a portion of a display 1600, each pixel having two adjacent green display elements, a red display element, and a blue display element arranged in the same configuration as illustrated in FIG. 15, the green display elements having a smaller active area than the red and blue display elements. The red, green and blue display elements are indicated in the display 1600 by a “R,” “G” and “B,” respectively.

As shown in FIG. 16, the display 1600 includes (representative) pixels 1602 and 1612. Directional references stated below refer to the relative orientation of the portion of the display 1600 depicted in FIG. 16. Pixel 1602 includes a red display element 1604, a first green display element 1605, a second green display element 1607, and a blue display element 1606. The first green display element 1605 is disposed laterally adjacent to and below the red display element 1604. The second green display element 1607 is disposed laterally adjacent to and beside the first green display element 1605 such that the first and second green display elements 1605 and 1607 are disposed in the same row. The blue display element 1606 is disposed below the second green display element 1607. Pixel 1612 includes a red display element 1614, a first green display element 1615, a second green display element 1617, and a blue display element 1616. The blue display element 1616 is disposed laterally adjacent to and above the first green display element 1615, and laterally adjacent to and beside the blue display element 1606 of pixel 1602. The first green display element 1615 is disposed laterally adjacent to and below the blue display element 1616. The second green display element 1617 is disposed laterally adjacent to and beside the first green display element 1615 such that the first and second green display elements 1615 and 1617 are disposed in the same row. The red display element 1614 is disposed laterally adjacent to and below the second green display element 1617.

In this implementation, the green display elements have smaller active areas, that is, smaller display areas, than the red and blue display elements. For example, the first green display element 1605 and the second green display element 1607 have active areas (or display areas) that are smaller than the active areas of the red display element 1604 and the blue display element 1606. In some implementations, the green display elements are fabricated to be smaller and have smaller active areas. In other implementations, the green display elements are the same size as the red and blue display elements but have a black mask that covers a portion of the display element reducing the active display area. Such an arrangement of pixels 1602 and 1612 with the described display element arrangements can be referred to herein as a “shifted quad pixel with smaller green display elements.”

As illustrated in FIG. 16, the display elements are arranged such that the display elements for each color are aligned in a stripe. For example, a stripe of red display elements 1630, a stripe of green display elements 1640, a stripe of blue display elements 1650, and a stripe of green display elements 1660, and this pattern can repeat throughout the display, the pattern being an “RGBG” pattern. One advantage of the shifted quad pixel implementation is that it allows COM (drive) lines to be connected to a single stripe. While some implementations, such as those illustrated in FIGS. 12, 13, and 14, allow for display elements of a single color in a row along extending in one direction to be connected to a single COM line, in such implementations, display elements of a single color are diagonally adjacent to each other. In the implementation of FIG. 16, display elements of a single color are laterally adjacent in a row along the first direction and hence, addressing display elements of a common color across the row is easier in the implementation of FIG. 16 when compared to the implementations of FIGS. 12-14. Also, while the shifted quad implementation illustrated in FIG. 15 shows green display elements that are all equal in active area size to the red and blue display elements, and the shifted quad implementation illustrated in FIG. 16 shows green display elements that are equal to each other in active area size with green display elements having active areas that are smaller than the red and blue display elements, it is understood that in some implementations, a single pixel may have a first green display element with an active area having a size equal to the red and blue display elements, but with a second green display element having a smaller active area than the other green display element, for example, as in the implementations of FIGS. 11 and 13. For example, with reference to FIG. 15, green display element 1505 may be equal to red and blue display elements 1504 and 1506, but green display element 1507 can be smaller than green display element 1505.

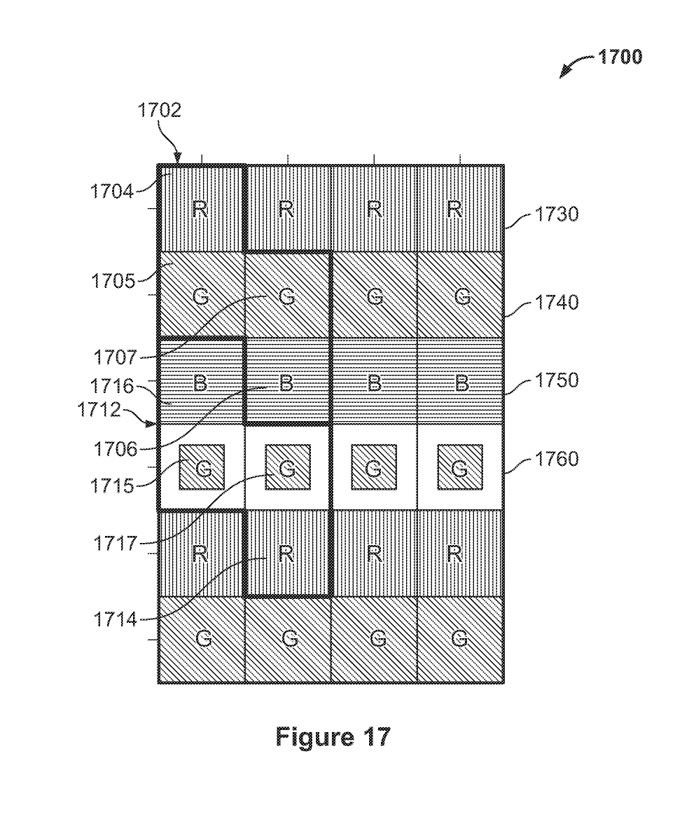

FIG. 17 shows an example of a plan view depicting pixels in a portion of a display 1700, each pixel having two adjacent green display elements, a red display element, and a blue display element arranged in the same configuration as illustrated in FIG. 15, the green display elements of every other pixel having an active area less than or equal to half of the size of the active area of both the red or blue display element. The red, green and blue display elements are indicated in the display 1700 by a “R,” “G” and “B,” respectively.

As shown in FIG. 17, the display 1700 includes (representative) pixels 1702 and 1712. Directional references stated below refer to the relative orientation of the portion of the display 1700 depicted in FIG. 17. Pixel 1702 includes a red display element 1704, a first green display element 1705, a second green display element 1707, and a blue display element 1706. The first green display element 1705 is disposed laterally adjacent to and below the red display element 1704. The second green display element 1707 is disposed laterally adjacent to and beside the first green display element 1705 such that the first and second green display elements 1705 and 1707 are disposed in the same row. The blue display element 1706 is disposed below the second green display element 1707. Pixel 1712 includes a red display element 1714, a first green display element 1715, a second green display element 1717, and a blue display element 1716. The blue display element 1716 is disposed laterally adjacent to and above the first green display element 1715, and laterally adjacent to and beside the blue display element 1706 of pixel 1702. The first green display element 1715 is disposed laterally adjacent to and below the blue display element 1716. The second green display element 1717 is disposed laterally adjacent to and beside the first green display element 1715 such that the first and second green display elements 1715 and 1717 are disposed in the same row. The red display element 1714 is disposed laterally adjacent to and below the second green display element 1717.

In this implementation, the green display elements in every other pixel have smaller active areas, that is, smaller display areas, than the red and blue display elements. For example, the first green display element 1705 and the second green display element 1707 have of pixel 1702 have active areas that are the same size as the active areas of the red display element 1704 and the blue display element 1706. However, in pixel 1012, first green display element 1715 and the second green display element 1717 have active areas that are half the size as the active areas of the red display element 1714 and the blue display element 1716. In some implementations, such green display elements are fabricated to be smaller and have smaller active areas. In other implementations, the green display elements are the same size as the red and blue display elements but have a black mask that covers a portion of the display element reducing the active display area. Such an arrangement of pixels 1702 and 1712 with the described display element arrangements can be referred to herein as a “shifted quad pixel with alternating pixels having half green display elements.”

As illustrated in FIG. 17, the display elements are arranged such that the display elements for each color are aligned in a stripe. For example, a stripe of red display elements 1730, a stripe of green display elements 1740, a stripe of blue display elements 1750, and a stripe of green display elements 1760, and this pattern can repeat throughout the display. One advantage of the shifted quad pixel implementation is that it allows COM (drive) lines to be connected to a single stripe.

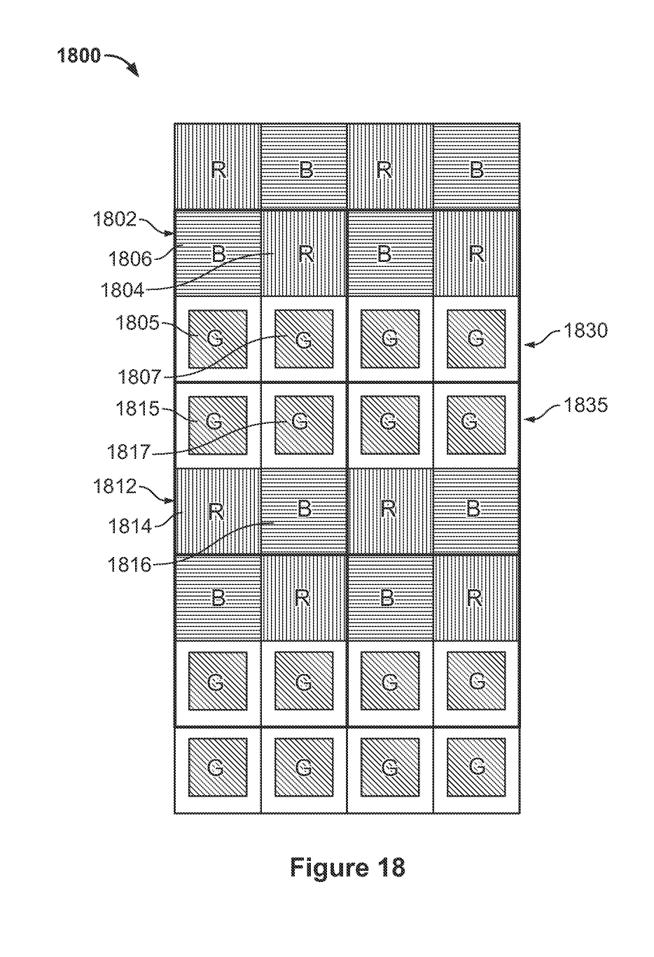

FIG. 18 shows an example of a plan view depicting pixels in a portion of a display 1800, each pixel having a red display element, a blue display element, and two adjacent green display elements arranged in a line, respectively, and the two green display elements each having an active area less than the active area of the red or blue display element. The red, green and blue display elements are indicated in the display 1800 by a “R,” “G” and “B,” respectively.

As shown in FIG. 18, the display 1800 includes (representative) pixels 1802 and 1812 that indicate a pattern of display elements that is repeated throughout the display 1800. Directional references stated below refer to the relative orientation of the portion of the display 1800 depicted in FIG. 18. The pixel 1802 includes a red display element 1804, a first green display element 1805, a second green display element 1807, and a blue display element 1806 arranged in a 2×2 configuration. The blue display element 1806 is disposed in a laterally adjacent to and beside the red display element 1804 such that the blue display element 1806 is on the left of the red display element 1804. The first green display element 1805 is disposed laterally adjacent and below the blue display element 1806. The second green display element 1807 is disposed laterally adjacent to and beside the first green element 1805, below the red display element 1804. The pixel 1812 includes a red display element 1814, a first green display element 1815, a second green display element 1817, and a blue display element 1816 arranged in a 2×2 configuration. The first green display element 1815 is disposed laterally adjacent to and beside the second green display element 1817 such that the first and second green display elements 1815 and 1817 are disposed in the same row. The red display element 1814 is disposed laterally adjacent and below the first green display element 1815. The blue display element 1816 is disposed laterally adjacent to and below the second green display element 1817, and beside the red display element 1814. In this implementation, the first and second green display elements 1805 and 1807 of the pixel 1802 are arranged adjacent to and below the first and second green display elements 1815 and 1817 of the pixel 1812 such that the green elements form a first and second stripe 1830 and 1835 of green display elements.

The arrangement of pixels and display elements of the implementation in FIG. 18 is similar but not identical to those illustrated in FIGS. 10 and 11. For example, in FIGS. 10, 11, and 18 the pixels are arranged in 2×2 quad configurations, each pixel having a red, blue, and two green display elements arranged side-by-side. The two green display elements in the pixels illustrated in FIGS. 10, 11, and 18 are arranged to be adjacent to the two green display elements of an adjacent pixel, forming two adjacent green display element stripes. However, in FIG. 10, the green display elements 1008, 1010, 1018 and 1020 are of equal size and equal in size to the red display elements 1004 and 1014 and blue display elements 1006 and 1016. In FIG. 11, each pixel (for example, pixel 1102) includes a green display element 1105 equal in size to the red display element 1104 and the blue display element 1106, and also includes a smaller green display element 1107. In FIG. 18, each pixel, as represented by pixel 1802, includes two green display elements 1805 and 1807 of equal size relative to each other, but the two green display elements 1805 and 1807 are smaller (that is, have a smaller active area) than the red display element 1804 or the blue display element 1806 in pixel 1802.

The green display elements in the display 1800 have active areas that are the same size and shape to each other, but are smaller than the active areas of the blue and red display elements. In some implementations, the green display elements are configured to have smaller active areas by using a black mask to obscure a portion of the display element that would otherwise be part of the active area. One advantage of this configuration is that the red, green and blue display elements can be connected to individual, dedicated COM lines for each color, as illustrated in FIG. 19. In some implementations, the COM lines are connected to the red, green and blue display elements by a conductive black mask configured as a routing line. For example, using a single layer, or more than one layer, of a black mask as a routing line.

FIG. 19A shows a schematic illustrating a plan view depicting lines coupled to display elements in a portion of the display 900 illustrated in FIG. 9, having two segment lines disposed between columns of the display elements. In the illustrated implementation, there are twice as many segment lines as there are columns of display elements. The red, green and blue display elements are indicated in the display 900 by a “R,” “G” and “B,” respectively. The red, green and blue display elements are illustrated in the same arrangement as shown in FIG. 9. Directional references stated below refer to the relative orientation of the portion of the display 900 depicted in FIG. 9 and are provided for clarity of the disclosure. This bus line structure allows different color display elements to have different actuation voltages and be addressable individually by a driver in such a way that display elements with the same actuation voltages may be addressed with a single COM line, even when display elements are arranged such that laterally adjacent display elements do not provide the same color. In other words, the display elements of a certain color can be connected to COM lines that only drive display elements of that color. Such implementations can also be advantageous to increase a frame refresh rate. For example, you can increase the frame rate by simultaneously updating two blue rows at the same time. COM line 1932 is connected to two rows of blue display elements and COM line 1935 is also connected to two rows of blue display elements. another line of blues. Providing a drive signal on either of COM lines 1932 or 1935 can address each of the blue display elements in the two rows the COM line is connected too because each blue display element in these two rows is connected to a different segment line. In another implementation, COM lines 1932 can 1934 can be connected to the same drive line 1944, and the blue display elements in the two rows that are connected to each of COM lines 1932 and 1934 can be addressed simultaneously because each blue display element is connected to a different segment line. This reduces the time it takes to update the screen by 50% or more, increasing the frame refresh rate by 2× or more. In some implementations, the display elements are connected by COM lines that are implemented in a single layer of a black mask routing scheme.

The bus line structure shown in FIG. 19A includes segment lines 1921-1928 aligned vertically between the columns of display elements. It is understood that FIG. 19A is a schematic representation (as are all figured illustrated herein) and the exact physical placement of segment lines 1921-1928 may not be as shown in FIG. 19A. Two segment lines are disposed between each column of display elements. For example, segment lines 1922 and 1923 are positioned between a first and second column of display elements 1980 and 1982. Segment lines 1924 and 1925 are positioned between the second column 1982 and a third column 1984 of display elements. Segment lines 1926 and 1927 are positioned between the third column 1984 and a fourth column 1986 of display elements. The segment lines are electrically connected to the display elements by connectors, for example, connectors 1950a and 1950b. For example, blue display element 1906 and green display element 1905 are connected to segment line 1921. Red display element 1915 and blue display element 1914 are connected to segment line 1922. Red display element 1904 and blue display element 1907 are connected to segment line 1923. Green display element 1917 and red display elements 1916 are connected to segment line 1924.

The bus line structure also includes COM lines 1930-1938, each COM line being connected to only one color of display elements that are disposed in one or two rows of the display 900 and in different columns of display elements. In the implementation illustrated in FIG. 19B, COM lines 1930 and 1933 are each connected to multiple green display elements, including green display elements arranged in different rows of the display 900. COM lines 1931 and 1934 are each connected to multiple red display elements, including red display elements arranged in different rows of the display 900. COM lines 1932 and 1935 are each connected to multiple blue display elements, including blue display elements arranged in different rows of the display 900. The COM lines 1930 and 1933 can be connected to a single drive line 1940. This is because the green display elements that are coupled to each of the different COM lines 1930 and 1933 are coupled to, and can by addressed by, a different segment line. Similarly, the COM lines 1931 and 1934 can be connected to a single drive line 1942 because different segment lines address the red display elements connected to these COM lines. The COM lines 1932 and 1934 can each be connected to a single drive line 1946 because different segment lines address the blue display elements connected to these COM lines. In such implementations, a single drive line can be used to drive display elements of the same color in two different rows, and the display elements in the two rows can be driven separately because each display element in the two rows is driven by a different segment line. FIG. 19A also illustrates a green drive line 1946 connected to COM line 1936, red drive line 1948 connected to COM line 1937, and blue drive line 1950 connected to COM line 1938. This second set of drive lines can be connected to other COM lines in the display 900, similarly to the green drive line 1940, the red drive line 1942, and the blue drive line 1944. In some implementations, a dual black mask architecture is used where segment lines are defined within the black mask. In some implementations, COM lines are formed in the top metal structure of the movable reflective layer of the display element, such as top metal layer 14c of the movable reflective layer 14 of FIG. 8E.

FIG. 19B shows an example of a plan view depicting driving lines coupled to display elements in a portion of the display 1800 illustrated in FIG. 18, which is similar to the arrangement of display 1000 in FIG. 10 and display 1100 in FIG. 11, having two segment lines disposed between columns of the display elements. In the illustrated implementation, there are twice as many segment lines as there are columns of display elements. The red, green and blue display elements are indicated in the display 1800 by a “R,” “G” and “B,” respectively. The red, green and blue display elements are illustrated in the same arrangement as shown in FIG. 18. Directional references stated below refer to the relative orientation of the portion of the display 1800 depicted in FIG. 18 and are provided for clarity of the disclosure.

FIG. 19B illustrates an implementation of a bus line structure that is used to provide drive signals to display elements. Similarly to the implementation shown in FIG. 19A, this bus line structure also allows different color display elements to have different actuation voltages and be addressable individually by a driver in such a way that display elements with the same actuation voltages may be addressed with a single COM line, even when display elements are arranged such that laterally adjacent display elements do not have the same color.

Still referring to FIG. 19B, the bus line structure includes segment lines 1821-1828 aligned vertically in FIG. 19B between the display elements. Two segment lines are disposed between each column of display elements. For example, segment lines 1822 and 1823 are positioned between a first and second column of display elements 1880 and 1882, segment lines 1824 and 1825 are positioned between the second and a third column of display elements 1882 and 1884, and segment lines 1826 and 1827 are positioned between the third column and a fourth column of display elements 1884 and 1886. The segment lines are electrically connected to the display elements via connectors, for example, connector 1850a connecting a red display element to the segment line 1821, and connector 1850b connecting a blue display element to the segment line 1823. For example, blue display element 1806 and green display element 1805 are connected to segment line 1821. Red display element 1804 and green display 1807 are connected to segment line 1823. Green display element 1815 and red display 1814 are connected to segment line 1822. Green display element 1817 and blue display 1816 are connected to segment line 1824.

The bus line structure also includes COM lines 1830-1837, each COM line being electrically connected to only one color of display elements by connectors, for example connectors 1860a and 1860b (other connectors are not explicitly labeled for clarity of FIG. 19B). In the implementation illustrated in FIG. 19B, COM lines 1830, 1832, 1834, and 1836 are each connected to multiple red display elements. COM lines 1831 and 1835 are each connected to multiple blue display elements, including blue display elements arranged in different rows of the display 1800. COM lines 1833 and 1837 are each connected to multiple green display elements, including green display elements arranged in different rows of the display 1800. The COM lines 1830, 1832, 1834, and 1836 can be connected to a single drive line 1840. This is because the red display elements that are coupled to each of the different COM lines 1830, 1832, 1834, and 1836 is addressed by a different segment line. Similarly, the COM lines 1831 and 1835 can be connected to a single drive line 1842 since different segment lines address the blue elements in the different COM lines. However, the drive line 1843 connected to green COM lines 1833 and the drive line 1844 connected to COM line 1837 are not connected together, in this implementation. Instead, in this configuration, a single green COM line 1833 is connected to each of the green display elements in two adjacent rows of the display 1800, for example, all of the green display elements in the fourth and fifth row of the display 1800. The green COM line 1837 is connected to all of the green display elements in the seventh and eighth row of display 1800. As illustrated in FIG. 19B, segment lines 1821-1828 are connected to a green display element in both the fourth or fifth row of display elements, and the seventh or eighth row of display elements. Accordingly, in this implementation, the green COM line 1837 is not connected to green COM line 1833 to allow each of the green display elements to be addressed individually, that is by a single driven segment line and a single driven COM line. Because they are not connected together, COM lines 1833 and 1837 each can be connected to two rows of green display elements, and since both of the rows are addressed by different segment lines, each line can simultaneously write data to the two rows. In some implementations, a switch on each of the COM lines 1833 and 1835 can isolate the COM lines from each other and the corresponding drive lines 1843 and 1844 can be connected. In some implementations, a dual black mask architecture is used where segment lines (for example, data lines) lines are defined within the black mask. In some implementations, COM lines are formed in the top metal structure of the movable reflective layer of the display element, such as top metal layer 14c of the movable reflective layer 14 of FIG. 8E.

FIG. 19C shows another example of a plan view depicting driving lines coupled to display elements in a portion of a display 2100. This implementation takes advantage of the display element arrangement so that in a quad pixel display elements of all three colors can be connected to individual, dedicated row drive lines (or COM lines) for each color. Such a row drive line can be, for example, one or more conductive layers of a black mask, thus utilizing existing structure of the display elements. Having a separate drive line (instead of a configuration where the display elements themselves form the drive line) also allows each display element to actuate more precisely as desired because each display element is subject to less electrical and charge effects from the other adjacent display elements during a write cycle.

The portion of the display 2100 illustrated in FIG. 19C includes a 4×8 array of display elements arranged in eight rows 2191-2198 and four columns 2181, 2183, 2185 and 2187. Individual display elements that are configured to reflect wavelengths of light that can be perceived as red, green and blue (in other words, red, green, and blue display elements) are indicated in the display 2100 by a “R,” “G” and “B,” respectively. The red, green and blue display elements illustrated in FIG. 19C are in the same arrangement as the display elements shown in FIGS. 12-14. Directional references refer to the relative orientation of the portion of the display 2100 depicted in FIG. 19C and are provided for clarity of the disclosure, and are not to be interpreted as limiting the orientation of the display or its components in any way.

As illustrated in FIG. 19C, the display includes segment lines 2121, 2131, 2123, 2133, 2125, 2135, 2127, and 2137 aligned vertically in the display 2100, with two segment lines disposed between each of the display column elements 2181, 2183, 2185 and 2187. For example, segment line 2121 is positioned to the left of display element column 2181, the leftmost display element column 2181 of the portion of display 2100 shown in FIG. 19C. Segment lines 2131 and 2123 are positioned between display element columns 2181 and 2183. Segment lines 2133 and 2125 are positioned between display element columns 2183 and 2185. Segment lines 2135 and 2127 are positioned between display element columns 2185 and 2187. The segment lines can be connected to a driver circuit, for example as illustrated by Column Driver Circuit 26 in FIG. 2, to provide drive signals (or drive voltages) to the display elements.

In this implementation, the segment lines 2121, 2131, 2123, 2133, 2125, 2135, 2127, and 2137 run between certain display element columns and are electrically coupled to certain display elements that are in the display element columns near or adjacent to the segment lines. For example, connector 2161 illustrates an electrical coupling between display element 2102 and segment line 2121. As indicated in FIG. 19C, segment line 2121 is coupled to certain display elements in display element column 2181, including red display element 2102, green display element 2112, and blue display element 2122. Also as illustrated, segment line 2131 is coupled to certain display elements in display element column 2181, specifically to green display element 2132 and the fifth (G), seventh (B) and eighth (G) display element. As may referred to herein, the display elements can be reference to the portion of the display illustrated from the top of the column down, for example, the fifth display element from the top of an illustrated column of display elements is sometime referred to as the fifth display element. Segment line 2123 is coupled to a green display element 2104 and a blue display element 2114, and to the fifth (G) and the eighth (R) display elements in display element column 2183. Segment line 2133 is coupled to green display element 2124 and red display element 2134, and to the sixth (B) and the seventh (G) display elements in display element column 2183. Segment line 2125 is coupled to red display element 2106, green display element 2116, blue display element 2126, and to the sixth (G) display element in display element column 2185. Segment line 2135 is coupled to green display element 2136 and the fifth (R), seventh (B) and eighth (G) display elements in display element column 2185. Segment line 2127 is coupled to green display element 2108, blue display element 2118 and to the fifth (G) and the eighth (R) display elements in display column 2187. Segment line 2137 is coupled to green display element 2128, red display element 2138, and to the sixth (B) and the seventh (G) display element in display element column 2187.

Throughout the display 2100, and as illustrated in the display element columns 2181, 2183, 2185 and 2187, the display element pattern R, G, B, G is repeated up and down the columns. However, as illustrated in the implementation of display 2100 in FIG. 19C, the repeated display element pattern is offset from the display element pattern in adjacent columns. This arrangement of display elements is also shown in FIGS. 12-14. Accordingly, the R, G and B display elements in display element column 2181 are aligned (horizontally) with the R, G and B display elements in display element column 2185, and are offset from the R, G and B display elements in display columns 2183 and 2187, which are aligned (horizontally) to each other. In rows 2191 and 2195 of the display 2100, the display elements from left to right are R, G, R and G. In rows 2192 and 2196 the display elements from left to right are G, B, G and B. In rows 2193 and 2197, the display elements from left to right are B, G, B and G. In rows 2194 and 2198, the display elements from left to right are G, R, G and R.

The arrangement of display elements in FIG. 19C uses COM lines 2144, 2146, 2152, 2154, 2156, 2162, 2164, 2166, and 2172 to provide drive signals to the display elements. The COM lines are electrically connected to the display elements by connectors 2160 (not all connectors are labeled for clarity of the illustration). For example, as illustrated in FIG. 19C, red row line 2156 is connected to red display elements 2134 and 2138, and also connected to the two red display elements in row 2195. In some implementations, and as illustrated in FIG. 19C, the red drive lines 2144 and 2156 can be connected such that a drive signal at R1 drive each of the coupled display elements. Connecting the common drive lines can minimize routing of red display element drive signals into the display. In the illustrated implementation with two segments lines disposed between the columns of display elements, each of the red display elements can be addressed separately even if certain common drive lines are connected. In some implementations where multiple red drive lines are connected to a single incoming drive line, certain drive (COM) lines can be isolated using switches (not shown) to address some of the multiple display elements of a certain color at any one time. In other implementations, each of the segment lines and each of the drive lines are connected to a driver circuit.

Similar to the red drive lines, green drive line 2146 is positioned between display elements in row 2191 and 2192, and is connected to the green display elements 2104, 2108, 2012 and 2116 in these rows. Green drive line 2154 is positioned between display element rows 2193 and 2194, and is connected to the green display elements in these two rows, namely green display elements 2132, 2136, 2124 and 2128. In some implementations, green drive line 2154 is connected to green drive line 2146. In this implementation, blue drive line 2152 is positioned between display element rows 2192 and 2193. Blue drive line 2152 is connected to blue display elements 2122, 2114, 2126 and 2118 in rows 2192 and 2193, and can also be connected to the blue display elements in rows 2192 and 2193. This pattern can be repeated for the rest of the display 2100.

FIGS. 19A, 19B and 19C illustrate display implementations that have two segment lines that are associated with a column of display elements and configured to independently address pixels in multiple rows of the column. In some implementations, a display can include two or more segment lines that are associated with a column of display elements. Each of the two or more segment lines is connected to a display element in one of multiple rows of display elements that are connected to two or more COM drive lines, which are electrically connected so that a single drive signal can be provided to the two or more COM drive lines. Increasing the number of segment lines that are associated with a column of display elements also increases the number of display elements in the column that can be driven independently when a signal is provided to the connected two or more drive lines. For example, in FIG. 19C, display element column 2185 includes green display element 2116 which is connected to drive line 2146 and green display element 2136 which is connected to drive line 2154, and drive lines 2146 and 2154 are electrically connected to the G1 drive terminal. Segment lines 2125 and 2135 are connected to green display elements 2116 and 2136, respectively. With this configuration, even though drive lines 2146 and 2154 are connected, each of green display element 2116 and 2136 can be driven individually because each is connected to a different segment line. Display element column 2185 also includes green display element 2173 which is connected to drive line 2162 and to segment line 2125, and green display element 2174 which is connected to drive line 2166 and segment line 2135. Drive lines 2162 and 2166 are electrically connected to the G2 terminal. Green display elements 2173 and 2174 can be driven separately because each is connected to a different segment line. However, in some implementations, there can be more than two segment lines associated/connected to a column of display elements. If display element column 2185 had four segment lines associated it, and each of the green display elements 2114, 2136, 2173 and 2174 were connected to a different segment line, drive lines 2146, 2154 2162 and 2164 could all be connected to a common G drive terminal and the green display elements connected to these drive lines could be driven separately.

FIGS. 20A and 20B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 20B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A passive matrix display apparatus, comprising:
a plurality of red display elements disposed in a first row such that each of the plurality of red display elements is disposed adjacent to at least one other of the plurality red display elements;
a plurality of green display elements disposed in a second row such that each of the plurality of green display elements is disposed adjacent to at least one other of the plurality green display elements;
a plurality of blue display elements disposed in a third row such that each of the plurality of blue display elements is disposed adjacent to at least one other of the plurality blue display elements; and
a second plurality of green display elements disposed in a fourth row such that each of the second plurality of green display elements is disposed adjacent to at least one other of the second plurality green display elements.

2. The display apparatus of claim 1, wherein the second row is adjacent to, and between, the first row and the third row, and wherein the third row is adjacent to, and between, the second row and the fourth row.

3. The display apparatus of claim 2, wherein the first row of red display elements, the second row green display elements, the third row of blue display elements, and the fourth row of green display elements define a four row display element pattern, and wherein the display further comprises at least four additional rows of display elements arranged in the four row display element pattern.

4. The display apparatus of claim 2, further comprising a repeating pattern of the first, second, third, and fourth rows of display elements.

5. The display apparatus of claim 2, further comprising a plurality of pixels, each pixel in the plurality of pixels including one red display element, a first green display disposed adjacent to the red display element, a second green display element disposed adjacent to the first green display element, and a blue display element disposed adjacent to the second green display element.

6. The display apparatus of claim 2, further comprising a plurality of pixels, each pixel in the plurality of pixels including one red display element disposed in the first row, two green display elements disposed in the second row, and one blue display element disposed in the third row.

7. The display apparatus of claim 2, further comprising
a plurality of red display elements disposed in a fifth row such that each of the display elements in the fifth row are disposed adjacent to at least one other red display element in the fifth row, where the fifth row is adjacent to the fourth row and disposed such that the fourth row is between the third row and the fifth row;
a first plurality of pixels, each pixel in the first plurality of pixels including one red display element of the first row, a first green display of the second row disposed adjacent to the red display element, a second green display element of the second row disposed adjacent to the first green display element, and a blue display element of the fourth row disposed adjacent to the second green display element; and
a second plurality of pixels, each pixel in the second plurality of pixels including one blue display element of the third row, a first green display of the fourth row disposed adjacent to the blue display element, a second green display element of the fourth row disposed adjacent to the first green display element, and a red display element of the fifth row disposed adjacent to the second green display element.

8. The display apparatus of claim 7, wherein the first green display elements, the second green display elements, the red display elements, and the blue display elements have the same size active area.

9. The display apparatus of claim 7, wherein the active areas of the first and second green display elements in a pixel in the first plurality of pixels are the same size as the active areas of the first and second green display elements in a pixel in the second plurality of pixel, and wherein the active areas of the green display elements are smaller than the active areas of the red display elements and smaller than the active areas of the blue display elements.

10. The display apparatus of claim 1, wherein the active areas of the green display elements of the second row are the same size as the active areas of the green elements of the fourth row, and wherein the active areas of the green display elements of the second and fourth row are smaller than the active areas of the red display elements and the blue display elements.

11. The display apparatus of claim 7, wherein the active areas of the green display elements in a pixel of the first plurality of pixels is larger than the active areas of the green display elements in a pixel of the second plurality of pixels.

12. The display apparatus of claim 1, wherein the active area of a green display element of the second row is the same size as the active area of a red display element in the first row and the active area of a blue display element in the third row, and wherein the active area of a green display element of the fourth row is smaller the active area of a green display element of the second row.

13. The display apparatus of claim 1, wherein the display elements are interferometric modulators.

14. The display apparatus of claim 1, further comprising:
a display including the plurality of red display elements, the first plurality of green display elements, the plurality of blue display elements, and the second plurality of green display elements;
a processor that is configured to communicate with the display, the processor being configured to process image data; and
a memory device that is configured to communicate with the processor.

15. The display apparatus of claim 14, further comprising a driver circuit configured to send at least one signal to the display.

16. The display apparatus of claim 15, further comprising a controller configured to send at least a portion of the image data to the driver circuit.

17. The display apparatus of claim 14, further comprising an image source module configured to send the image data to the processor.

18. The display apparatus of claim 17, wherein the image source module includes at least one of a receiver, transceiver, and transmitter.

19. A passive matrix display apparatus, comprising:
means for displaying red information in a first row, the red displaying means each disposed adjacent to at least one other red displaying means in the first row;
means for displaying green information in a second row, the green displaying means each disposed adjacent to at least one other green displaying means in the second row;
means for displaying blue information in a third row, the blue displaying means each disposed adjacent to at least one other blue displaying means in the third row; and
means for displaying green information in a fourth row, the green displaying means each disposed adjacent to at least one other green displaying means in the fourth row,
a first plurality of pixels, each pixel in the first plurality of pixels including a red displaying means of the first row, a first green displaying means of the second row disposed adjacent to the red displaying means, a second green displaying means of the second row disposed adjacent to the first green displaying means, and a blue displaying means disposed adjacent to the second green displaying means,
wherein the second row is adjacent to, and between, the first row and the third row, and wherein the third row is adjacent to, and between, the second row and the fourth row.

20. The display apparatus of claim 19,
wherein the red displaying means includes a plurality of interferometric modulators configured to reflect red-colored light,
wherein the green displaying means includes a plurality of interferometric modulators configured to reflect green-colored light, and
wherein the blue displaying means includes a plurality of interferometric modulators configured to reflect blue-colored light.

21. A method of manufacturing a passive matrix display apparatus, comprising:
providing a plurality of red display elements disposed in a first row such that each of the plurality of red display elements is disposed adjacent to at least one other of the plurality red display elements;
providing a plurality of green display elements disposed in a second row such that each of the plurality of green display elements is disposed adjacent to at least one other of the plurality green display elements;
providing a plurality of blue display elements disposed in a third row such that each of the plurality of blue display elements is disposed adjacent to at least one other of the plurality blue display elements;
providing a second plurality of green display elements disposed in a fourth row such that each of the second plurality of green display elements is disposed adjacent to at least one other of the second plurality green display elements, wherein the second row is disposed adjacent to, and between, the first row and the third row, and wherein the third row is disposed adjacent to, and between, the second row and the fourth row, and
providing a repeating pattern of the first, second, third, and fourth rows of display elements to form an arrangement of display elements of a display.

22. The method of claim 21, further comprising configuring a plurality of pixels from the display elements of the display, each pixel in the plurality of pixels including one red display element, a first green display disposed adjacent to the red display element, a second green display element disposed adjacent to the first green display element, and a blue display element disposed adjacent to the second green display element.

23. The method of claim 21, further configuring a plurality of pixels from the display elements of the display, each pixel in the plurality of pixels including one red display element disposed in the first row, two green display elements disposed in the second row, and one blue display element disposed in the third row.

24. The method of claim 21, further comprising
providing a plurality of red display elements disposed in a fifth row such that each of the display elements in the fifth row are disposed adjacent to at least one other red display element in the fifth row, where the fifth row is adjacent to the fourth row and disposed such that the fourth row is between the third row and the fifth row;
configuring a first plurality of display elements of the array to form a first plurality of pixels, each pixel in the first plurality of pixels including one red display element of the first row, a first green display of the second row disposed adjacent to the red display element, a second green display element of the second row disposed adjacent to the first green display element, and a blue display element of the fourth row disposed adjacent to the second green display element; and
configuring a second plurality of display elements of the array to form a second plurality of pixels, each pixel in the second plurality of pixels including one blue display element of the third row, a first green display of the fourth row disposed adjacent to the blue display element, a second green display element of the fourth row disposed adjacent to the first green display element, and a red display element of the fifth row disposed adjacent to the second green display element.
